(19) United States
(12) Patent Application Publication
(10) Pub. No.: US 2025/0384443 A1
(43) Pub. Date: Dec. 18, 2025

(54) Technologies for Performing Multimodal Financial Entity Resolution

(71) Applicant: The PNC Financial Services Group, Inc., Pittsburgh, PA (US)

(72) Inventor: Abhishek Gupta, Sewickley, PA (US)

(21) Appl. No.: 19/087,844

(22) Filed: Mar. 24, 2025

Related U.S. Application Data
(60) Provisional application No. 63/659,935, filed on Jun. 14, 2024.

(51) Int. Cl. G06Q 20/40; G06F 16/215

(52) U.S. Cl. CPC G06Q 20/4014; G06F 16/215

(57) ABSTRACT

Technologies for performing multimodal entity resolution include a compute device. The compute device includes circuitry configured to obtain financial transaction data indicative of financial transactions associated with a financial institution. The circuitry may be further configured to perform one or more deterministic operations on the obtained financial transaction data in a relational database format to resolve identities of entities associated with the financial transactions. Additionally, the circuitry may be configured to perform one or more graph traversal operations on the financial transaction data to resolve additional identities of the entities associated with the financial transactions.

### RELATED APPLICATIONS

This application claims the benefit of U.S. Provisional Application No. 63/659,935 filed Jun. 14, 2024 for “Technologies for Performing Multimodal Financial Entity Resolution,” which is hereby incorporated by reference in its entirety.

### BACKGROUND

Financial institutions play a multi-faceted role in the global economy, and one of the primordial roles being that of a financial intermediary, to facilitate transactions among entities (e.g., parties to a transaction). Typically, those transactions involve either one or more financial institutions, or a financial institution and its customers or another party (e.g., an external entity), or a customer of the financial institution transacting with another party (e.g., an external entity). The transactions may be conducted through a variety of payment processing channels, such as automated clearinghouse systems, wire transfers, real time payments, payment card networks, or others, and the available information about the parties to a given transaction varies based the payment processing system(s) through which the transaction was processed. With regard to external entities in particular, limited information is readily available. As such, from a technical perspective, it is difficult for a financial institution to obtain a cohesive informed view of the connected entities involved in such transactions. This hole in the financial technology landscape may be exploited by fraudsters and other malicious agents.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements. The detailed description particularly refers to the accompanying figures in which:

FIG. 1 is a simplified block diagram of at least one embodiment of a system for performing multimodal entity resolution;

FIG. 2 is a simplified block diagram of at least one embodiment of a compute device of the system of FIG. 1;

FIGS. 3-11 are simplified block diagrams of at least one embodiment of a method for performing multimodal entity resolution that may be performed by the system of FIG. 1; and

FIG. 12 is a chart of transaction breadcrumb data that may be analyzed by the system of FIG. 1;

FIG. 13 is a chart of transactions and entity resolutions that may be determined by the system of FIG. 1 while performing the method of FIGS. 3-9

FIG. 14 is a simplified diagram of an embodiment of the system of FIG. 1; and

FIGS. 15-23 are diagrams of operations that may be performed on data to facilitate entity resolution.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

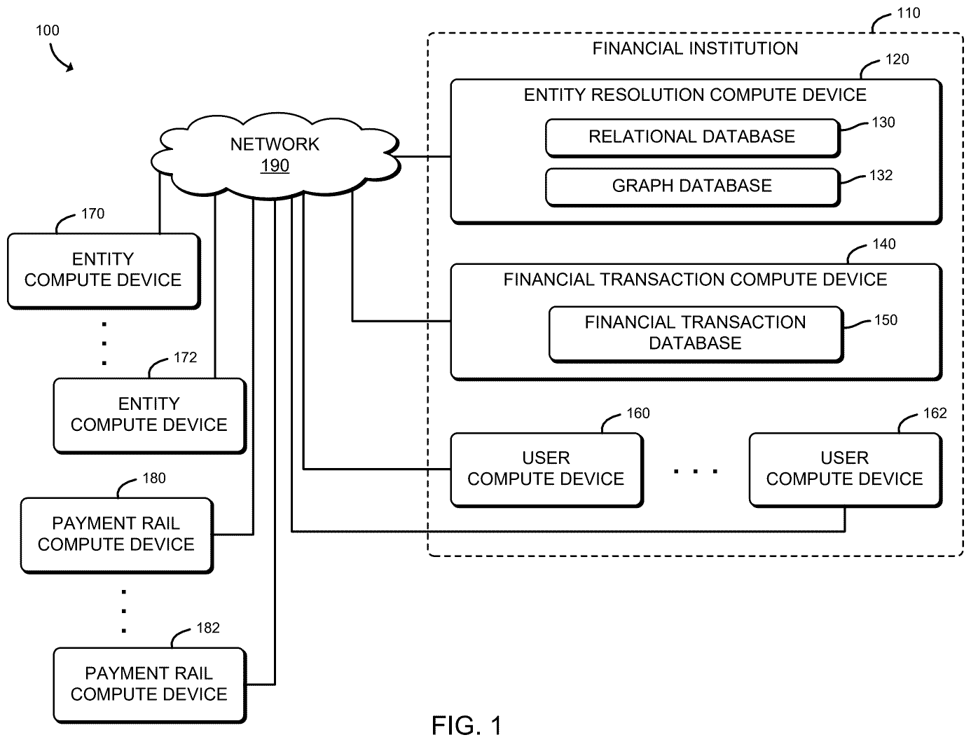

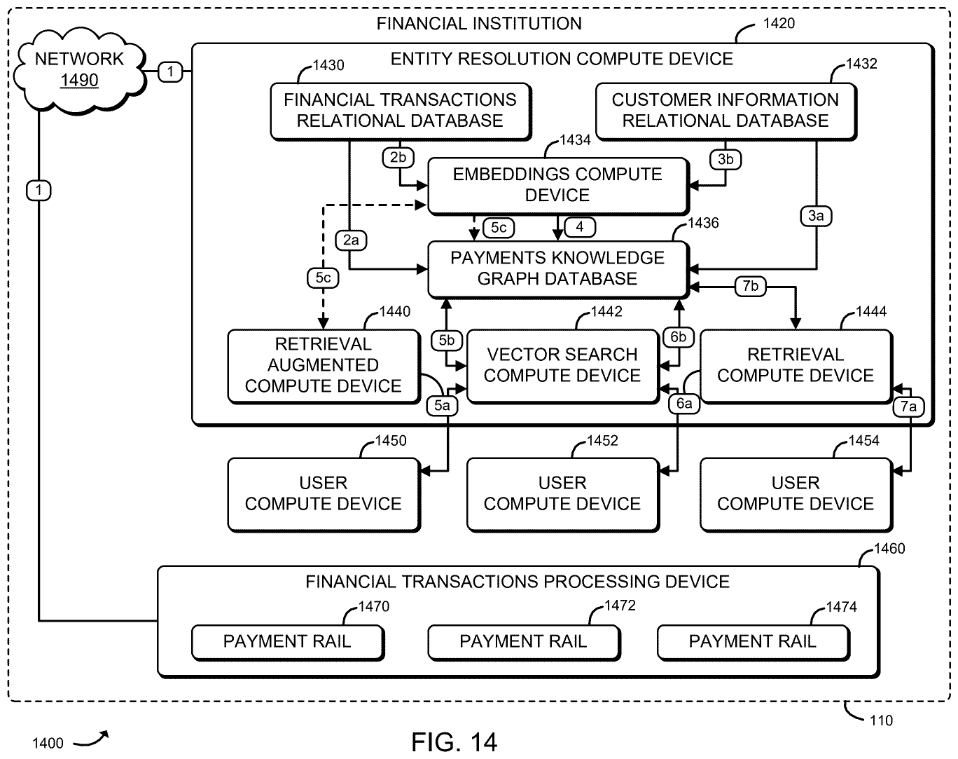

Referring now to FIG. 1, a system 100 for performing multimodal entity resolution includes, in the illustrative embodiment, an entity resolution compute device 120 communicatively connected to a financial transaction compute device 140, and user computer devices 160, 162. Another, more detailed diagram 1400 of an embodiment of the system is provided in FIG. 14, which is described later. Still referring to FIG. 1, the system 100 also includes entity compute devices 170, 172 which may be utilized by parties to transactions (e.g., senders of money and receivers of money). Additionally, the system 100 includes payment rail compute devices 180, 182 which may be utilized to process payment transactions carried out through corresponding payment systems (e.g., “payment rails” such as payment card network systems, automated clearinghouse systems, real time payment systems, digital payment network systems, such as Zelle, etc.). The transactions typically involve at least one entity (e.g., party) that holds an account with the financial institution 110. As such, the financial transaction compute device 140, in the illustrative embodiment, performs operations internal to the financial institution 110 to facilitate transactions between entities (e.g., parties) associated with the entity compute devices 170, 172, including adding to the account balance of an account holder or deducting from the account balance of the account holder in accordance with a corresponding transaction in which one or more of the parties (e.g., entities) is an account holder with the financial institution 110. Further, in operation, the financial transaction compute device 140 continually updates a financial transaction database 150 (e.g., a system of record) that reflects the transactions associated with accounts with the financial institution 110, including data used to facilitate the transactions (e.g., breadcrumb data, such as routing number and account number combinations, merchant names or other identifiers, and tokens (e.g., entity phone numbers, email addresses, geolocation, IP addresses, device ID's, etc.) associated with transactions through certain digital payment networks (e.g., Zelle or online payments)).

In operation, the entity resolution compute device 120 analyzes financial transaction data from the financial transaction database 150 to resolve (e.g., determine) the identities of the external entities associated with the transactions facilitated by the financial institution 110. In doing so, the entity resolution compute device 120 performs multiple modes of entity resolution, including deterministic entity resolution operations (e.g., performing programmatic decisions based on high explainability (e.g., readily explainable by a human reviewer) thresholds, using data in a relational data format (e.g., in a relational database 130, in which data is organized into rows and columns, which collectively form a table and in which the data may be structured across multiple tables, which may be joined by one or more primary keys or foreign keys)) and graph traversal based entity resolution, in which the entity resolution compute device 120 populates a graph data structure (e.g., a graph database 132, in which data is stored as nodes and connections between the nodes) based on the financial transaction data and determinations from the deterministic entity resolution operations, to identify correlations between entities using graph traversal operations. Doing so reveals insights (e.g., that two apparently different entities are actually the same entity) that are not readily ascertainable from the deterministic entity resolution operations. Further, the entity resolution compute device 120 provides the results of the multimodal entity resolution analysis to a portal (e.g., a user interface, such as a web-based user interface) for review by human analysts (e.g., users of the user compute devices 160, 162).

Typically, the financial services industry relies on external data aggregators and providers (e.g., via subscriptions or other paid arrangements) to gather insights regarding external entities (e.g., non-customers of the financial institution 110, who are parties to transactions with customers of the financial institution 110). The information provided from such aggregators or providers often presents a divided picture based on whether the data was sought from a consumer perspective as compared to a commercial perspective. That is, the kind of information available from a credit bureau (e.g., FICO) may differ significantly from financial data associated with a publicly traded company. Further, such sources do not provide insights regarding transactional behavior of the entities. Relying on transactional data collected by the financial institution 110 is a messy affair, as illustrated by the following examples. In one example, a “John Doe” sends money from Bank 1 and another “John Doe” sends money from Bank 2. In both instances, the money is sent to the same deposit account with the financial institution 110. However, the “John Doe” in the two transactions cannot be classified as a single entity based only on the name and the bank details. Conversely, a “John Doe” and a “John Doe Jr” cannot necessarily be said to be separate entities based simply on slight differences in their names.

Even for corporate transactions, since the names associated with entities may be set up with different banks, at different times, in different systems, there could be many versions of an external entity's name that appears across the payment rails (e.g., transactions processed through the various payment rail compute devices 180, 182) from the same routing and account number combination (e.g., ABC, LLC; ABC LLC; ABC Limited Liability; ABC). As another example, “John Doe” as a customer of the financial institution 110 sending money to “Mary Joe” at another bank does not definitively indicate that they are part of the same family or that “Mary Joe” is also a secondary beneficiary on the account of “John Doe” at the financial institution 110. In view of the indeterminacy of the entities in the financial transaction data, it is technically difficult for a financial institution (e.g., the financial institution 110) to draw conclusions as to how to adapt its services to better serve its customers and to manage risk for the financial institution 110 (e.g., with respect to potential financial crimes). Knowing more about these connected entities, and the ability to leverage such insights to preempt and prevent such malicious activities or contagion risk, is fundamental to the objectives of continuing to maintain trust and reliability in the financial system. Once such networks have been established, there is significant potential beyond risk management, to monetize such networks for revenue expansion opportunities, reducing friction in transactions and other banking services, and the overall ability to better serve the customers. By performing the multimodal entity resolution operations described in more detail herein, the entity resolution compute device 120 overcomes the lack of available data regarding the identities and transactional behavior of entities (e.g., utilizing the entity compute devices 170, 172), to enable the financial institution 110 to enhance its services and better manage risk.

While relatively few compute devices 120, 140, 160, 162, 170, 172, 180, 182 are shown in FIG. 1 for simplicity and clarity, it should be understood that the number of compute devices, in practice, may range in the tens, hundreds, thousands, or more. Likewise, it should be understood that the compute devices 120, 140, 160, 162, 170, 172, 180, 182 may be distributed differently or perform different roles than the configuration shown in FIG. 1. Further, though shown as separate compute devices 120, 140, 160, 162, 170, 172, 180, 182, in some embodiments, the functionality of one or more of the compute devices 120, 140, 160, 162, 170, 172, 180, 182 may be combined into fewer compute devices (the entity resolution compute device 120 may be combined with the financial transaction compute device 140) and/or distributed across more compute devices than those shown in FIG. 1 (e.g., the entity resolution compute device 120 may comprise multiple compute devices and/or the financial transaction compute device 140 may comprise multiple compute devices distributed across more compute devices than shown in FIG. 1).

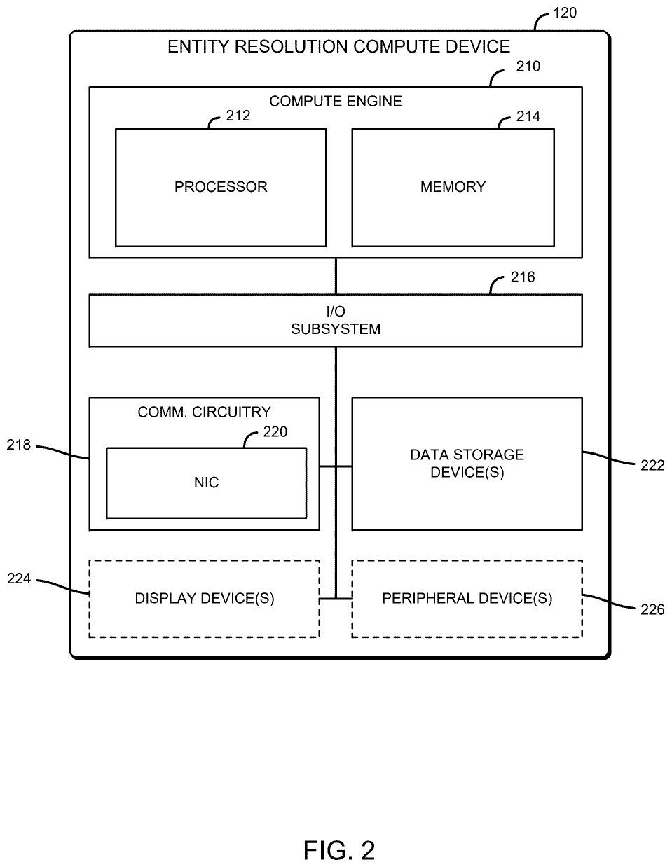

Referring now to FIG. 2, the illustrative entity resolution compute device 120 includes a compute engine 210, an input/output (I/O) subsystem 216, communication circuitry 218, and one or more data storage devices 222. In some embodiments, the entity resolution compute device 120 may include one or more display devices 224 and/or one or more peripheral devices 226 (e.g., a mouse, a physical keyboard, etc.). In some embodiments, one or more of the illustrative components may be incorporated in, or otherwise form a portion of, another component. The compute engine 210 may be embodied as any type of device or collection of devices capable of performing various compute functions described below. In some embodiments, the compute engine 210 may be embodied as a single device such as an integrated circuit, an embedded system, a field-programmable gate array (FPGA), a system-on-a-chip (SOC), or other integrated system or device. Additionally, in the illustrative embodiment, the compute engine 210 includes or is embodied as a processor 212 and a memory 214. The processor 212 may be embodied as any type of processor capable of performing the functions described herein. For example, the processor 212 may be embodied as a single or multi-core processor(s), a microcontroller, or other processor or processing/controlling circuit. In some embodiments, the processor 212 may be embodied as, include, or be coupled to an FPGA, an application specific integrated circuit (ASIC), reconfigurable hardware or hardware circuitry, or other specialized hardware to facilitate performance of the functions described herein.

In embodiments, the processor 212 is capable of receiving, e.g., from the memory 214 or via the I/O subsystem 216, a set of instructions which when executed by the processor 212 cause the entity resolution compute device 120 to perform one or more operations described herein. In embodiments, the processor 212 is further capable of receiving, e.g., from the memory 214 or via the I/O subsystem 216, one or more signals from external sources, e.g., from the peripheral devices 226 or via the communication circuitry 218 from an external compute device, external source, or external network. As one will appreciate, a signal may contain encoded instructions and/or information. In embodiments, once received, such a signal may first be stored, e.g., in the memory 214 or in the data storage device(s) 222, thereby allowing for a time delay in the receipt by the processor 212 before the processor 212 operates on a received signal. Likewise, the processor 212 may generate one or more output signals, which may be transmitted to an external device, e.g., an external memory or an external compute engine via the communication circuitry 218 or, e.g., to one or more display devices 224. In some embodiments, a signal may be subjected to a time shift in order to delay the signal. For example, a signal may be stored on one or more storage devices 222 to allow for a time shift prior to transmitting the signal to an external device. One will appreciate that the form of a particular signal will be determined by the particular encoding a signal is subject to at any point in its transmission (e.g., a signal stored will have a different encoding that a signal in transit, or, e.g., an analog signal will differ in form from a digital version of the signal prior to an analog-to-digital (A/D) conversion).

The main memory 214 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. In some embodiments, all or a portion of the main memory 214 may be integrated into the processor 212. In operation, the main memory 214 may store various software and data used during operation such as financial transaction data, breadcrumb data, predefined similarity thresholds, applications, libraries, and drivers.

The compute engine 210 is communicatively coupled to other components of the entity resolution compute device 120 via the I/O subsystem 216, which may be embodied as circuitry and/or components to facilitate input/output operations with the compute engine 210 (e.g., with the processor 212 and the main memory 214) and other components of the entity resolution compute device 120. For example, the I/O subsystem 216 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 216 may form a portion of a system-on-a-chip (SoC) and be incorporated, along with one or more of the processor 212, the main memory 214, and other components of the entity resolution compute device 120, into the compute engine 210.

The communication circuitry 218 may be embodied as any communication circuit, device, or collection thereof, capable of enabling communications over a network between the entity resolution compute device 120 and another device (e.g., a compute device 140, 160, 162, 170, 172, 180, 182, etc.). The communication circuitry 218 may be configured to use any one or more communication technology (e.g., wired or wireless communications) and associated protocols (e.g., Ethernet, Wi-Fi®, WiMAX, Bluetooth®, etc.) to effect such communication.

The illustrative communication circuitry 218 includes a network interface controller (NIC) 220. The NIC 220 may be embodied as one or more add-in-boards, daughter cards, network interface cards, controller chips, chipsets, or other devices that may be used by the entity resolution compute device 120 to connect with another compute device (e.g., a compute device 140, 160, 162, 170, 172, 180, 182, etc.). In some embodiments, the NIC 220 may be embodied as part of a system-on-a-chip (SoC) that includes one or more processors, or included on a multichip package that also contains one or more processors. In some embodiments, the NIC 220 may include a local processor (not shown) and/or a local memory (not shown) that are both local to the NIC 220. Additionally or alternatively, in such embodiments, the local memory of the NIC 220 may be integrated into one or more components of the entity resolution compute device 120 at the board level, socket level, chip level, and/or other levels.

Each data storage device 222, may be embodied as any type of device configured for short-term or long-term storage of data such as, for example, memory devices and circuits, memory cards, hard disk drives, solid-state drives, or other data storage device. Each data storage device 222 may include a system partition that stores data and firmware code for the data storage device 222 and one or more operating system partitions that store data files and executables for operating systems.

Each display device 224 may be embodied as any device or circuitry (e.g., a liquid crystal display (LCD), a light emitting diode (LED) display, a cathode ray tube (CRT) display, etc.) configured to display visual information (e.g., text, graphics, etc.) to a user. In some embodiments, a display device 224 may be embodied as a touch screen (e.g., a screen incorporating resistive touchscreen sensors, capacitive touchscreen sensors, surface acoustic wave (SAW) touchscreen sensors, infrared touchscreen sensors, optical imaging touchscreen sensors, acoustic touchscreen sensors, and/or other type of touchscreen sensors) to detect selections of on-screen user interface elements or gestures from a user.

In the illustrative embodiment, the components of the entity resolution compute device 120 are housed in a single unit. However, in other embodiments, the components may be in separate housings, in separate racks of a data center, and/or spread across multiple data centers or other facilities. The compute devices 140, 160, 162, 170, 172, 180, 182 may have components similar to those described in FIG. 2 with reference to the entity resolution compute device 120. The description of those components of the entity resolution compute device 120 is equally applicable to the description of components of the compute devices 140, 160, 162, 170, 172, 180, 182. Further, it should be appreciated that any of the devices 120, 140, 160, 162, 170, 172, 180, 182 may include other components, sub-components, and devices commonly found in a computing device, which are not discussed above in reference to the entity resolution compute device 120 and not discussed herein for clarity of the description.

In the illustrative embodiment, the compute devices 120, 140, 160, 162, 170, 172, 180, 182, are in communication via a network 190, which may be embodied as any type of wired or wireless communication network, including global networks (e.g., the internet), wide area networks (WANs), local area networks (LANs), digital subscriber line (DSL) networks, cable networks (e.g., coaxial networks, fiber networks, etc.), cellular networks (e.g., Global System for Mobile Communications (GSM), Long Term Evolution (LTE), Worldwide Interoperability for Microwave Access (WiMAX), 3G, 4G, 5G, etc.), a radio area network (RAN), or any combination thereof.

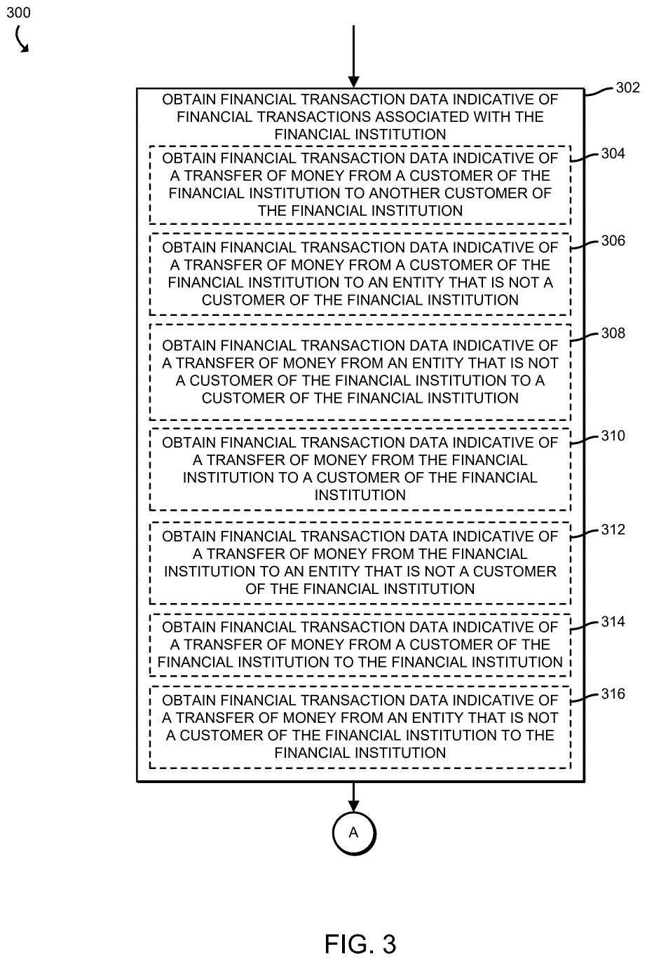

Referring now to FIG. 3, the system 100, and more specifically, the entity resolution compute device 120, in the illustrative embodiment, may perform a method 300 for multimodal entity resolution (e.g., to determine the identities of entities involved in financial transactions associated with the financial institution 110 or customers of the financial institution 110). The method 300 begins with block 302 in which the entity resolution compute device 120 obtains (e.g., from the financial transaction database 150) financial transaction data indicative of financial transactions associated with the financial institution 110. In doing so, and as indicated in block 304, the entity resolution compute device 120 may obtain financial transaction data indicative of a transfer of money from a customer of the financial institution 110 to another customer of the financial institution 110. Additionally or alternatively, the entity resolution compute device 120 may obtain financial transaction data indicative of a transfer of money from a customer of the financial institution 110 to an entity that is not a customer of the financial institution 110 (e.g., does not have an account with the financial institution 110), as indicated in block 306. The entity resolution compute device 120 may also obtain financial transaction data indicative of a transfer of money from an entity that is not a customer of the financial institution 110 to a customer of the financial institution 110, as indicated in block 308.

Additionally or alternatively, the entity resolution compute device 120 may obtain financial transaction data indicative of a transfer of money from the financial institution 110 itself to a customer of the financial institution 110, as indicated in block 310. Further, the entity resolution compute device 120 may obtain financial transaction data indicative of a transfer of money from the financial institution 110 to an entity that is not a customer of the financial institution 110, as indicated in block 312. The entity resolution compute device 120 may also obtain financial transaction data indicative of a transfer of money from a customer of the financial institution 110 to the financial institution 110, as indicated in block 314. Additionally or alternatively, the entity resolution compute device 120 may obtain financial transaction data indicative of a transfer of money from an entity that is not a customer of the financial institution 110 to the financial institution 110, as indicated in block 316. While a single transaction of each of the above types is described above, it should be understood that the entity resolution compute device 120 may obtain financial transaction data indicative of multiple transactions of any of the types described above.

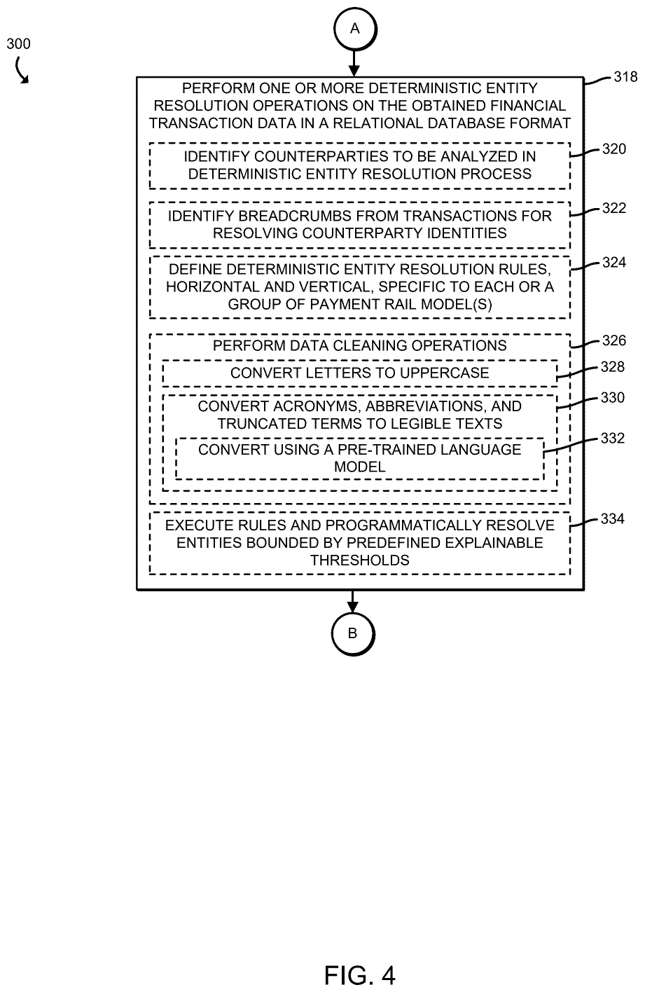

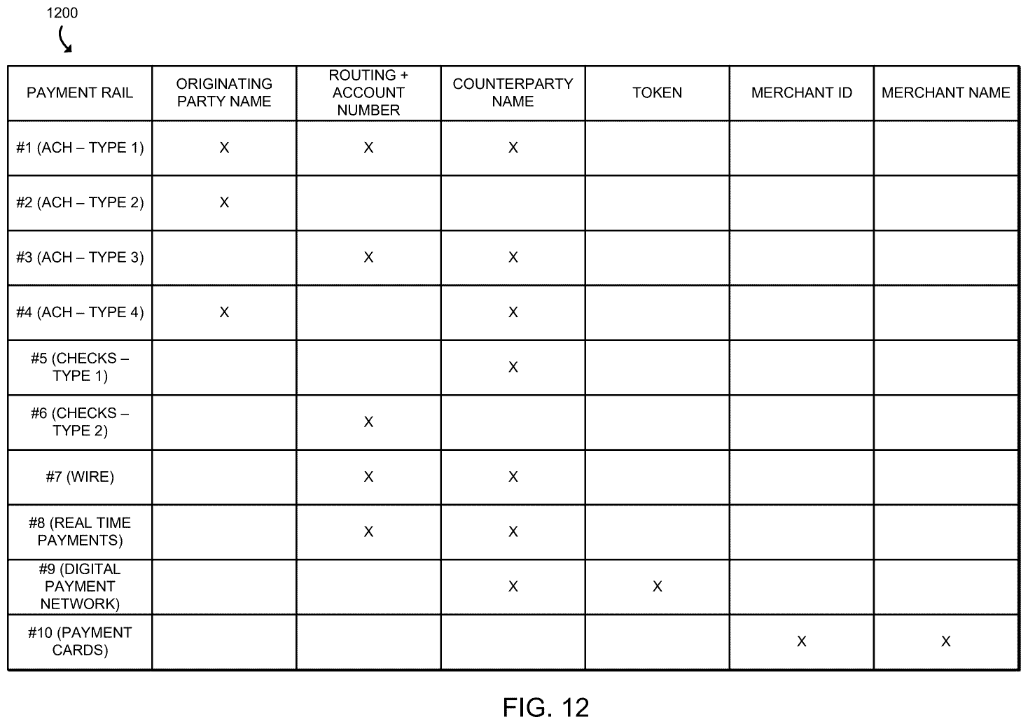

Referring now to FIG. 4, the method 300, in the illustrative embodiment, advances to block 318 in which the entity resolution compute device 120 performs one or more deterministic entity resolution operations on the obtained financial transaction data (e.g. from block 302) in a relational database format. That is, the entity resolution compute device 120 operates on the data in a format (e.g., in the relational database 130, which may be a PostgreSQL database, an Oracle database, a Microsoft SQL Server database, or the like) in which data is organized in rows and columns that form tables and in which one or more tables are connect by keys (primary keys, foreign keys, etc.). As indicated in block 320, the entity resolution compute device 120 identifies counterparties to be analyzed in a deterministic entity resolution process. Further, and as indicated in block 322, the entity resolution compute device 120 identifies breadcrumbs from transactions for resolving counterparty identities. Breadcrumbs may be embodied as any data that is indicative of one or more identifiers utilized to conduct a corresponding financial transaction. A chart 1200 in FIG. 12 illustrates breadcrumbs that may be utilized by the entity resolution compute device 120 for transactions that are processed via different payment rails. In block 324, the entity resolution compute device 120 defines deterministic entity resolution rules, horizontal and vertical, specific to each or a group of payment rail models. In block 326, the entity resolution compute device 120 performs data cleaning operations. As indicated in block 328, the entity resolution compute device 120 may convert letters to uppercase. Further, and as indicated in block 330, the entity resolution compute device 120 may convert acronyms, abbreviations, and/or truncated terms to legible texts. In doing so, and as indicated in block 332, the entity resolution compute device 120 may perform the conversion using a pre-trained language model. In the illustrative embodiment, the entity resolution compute device 120 executes the rules and programmatically resolves entities bounded by predefined explainable thresholds, as indicated in block 334.

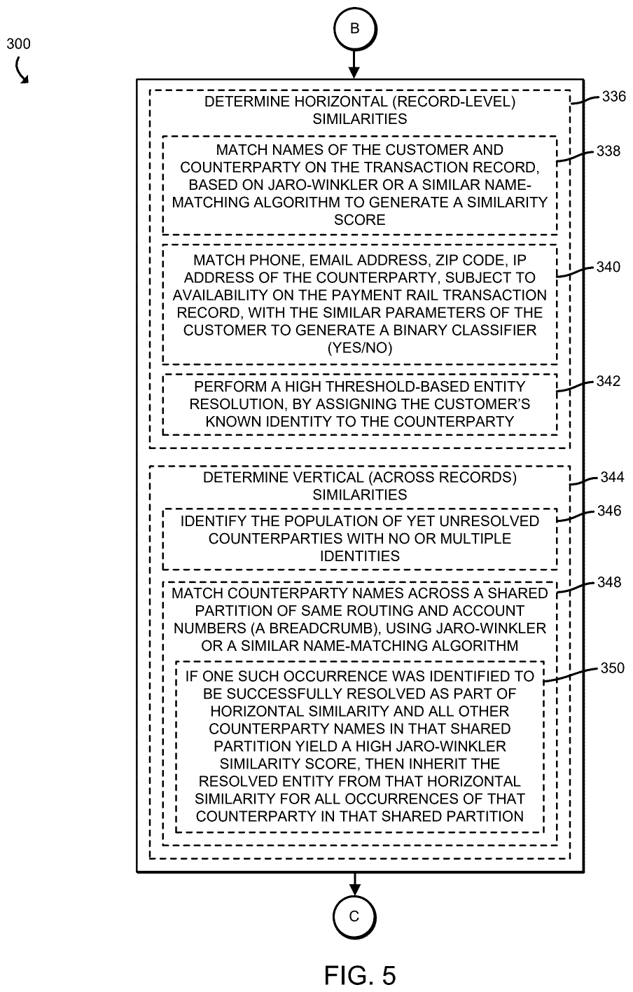

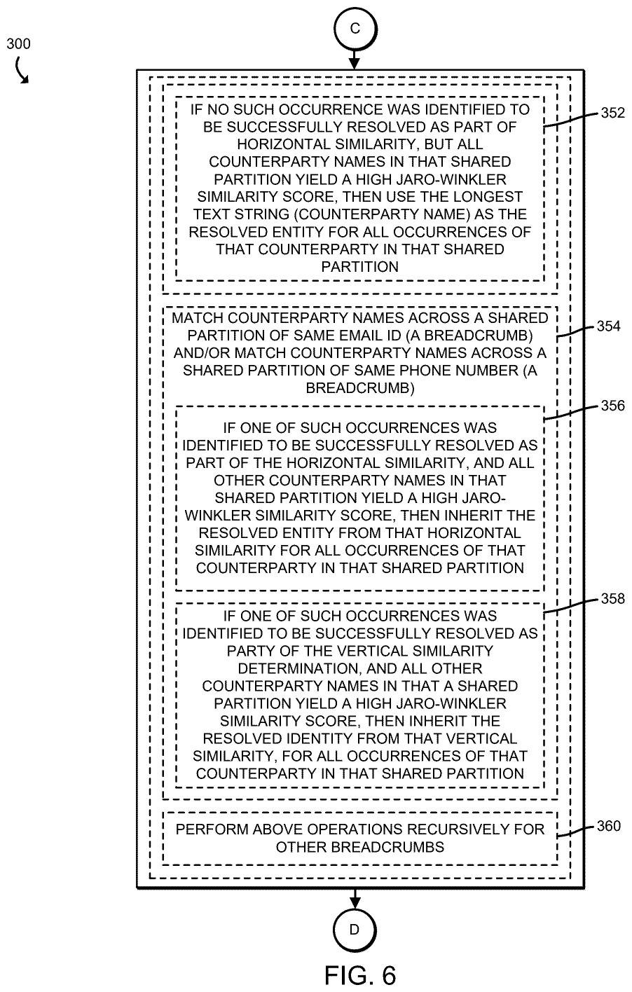

Referring now to FIG. 5, the entity resolution compute device 120, in performing the deterministic entity resolution operations, may determine horizontal (e.g., record level) similarities, as indicated in block 336. In doing so, the entity resolution compute device 120 may match names of the customer and counterparty on the transaction record, based on a Jaro-Winkler or similar name-matching algorithm, to generate a similarity score, as indicated in block 338. Further, and as indicated in block 340, the entity resolution compute device 120 may match the phone number, email address, zip code, and/or internet protocol (IP) address of the counterparty, subject to availability on the payment rail transaction record, with the similar parameters of the customer to generate a binary classifier (e.g., yes or no). As indicated in block 342, the entity resolution compute device 120 may perform high threshold-based entity resolution, by assigning the customer's known identity to the counterparty. The entity resolution compute device 120, in the illustrative embodiment, also determines vertical (e.g., across records) similarities, as indicated in block 344. In doing so, and as indicated in block 346, the entity resolution compute device 120 may identify the population of yet unresolved counterparties with no or multiple identities. Further, and as indicated in block 348, the entity resolution compute device 120, in the illustrative embodiment, matches counterparty names across a shared partition of same routing and account numbers (e.g., a breadcrumb), using a Jaro-Winkler or similar name-matching algorithm. As indicated in block 350, in the illustrative embodiment, if one such occurrence was identified to be successfully resolved as part of the horizontal similarity operations and all other counterparty names in that shared partition yield a high Jaro-Winkler similarity score (e.g., a score satisfying a threshold defined as high), then the entity resolution compute device 120 inherits the resolved entity from that horizontal similarity for all occurrences of that counterparty in that shared partition. Alternatively, if the partition associated with block 348 had no previous matches from horizontal similarity, the entity resolution compute device 120 may perform the operation of block 352 shown in FIG. 6. In block 352, if no occurrence was identified to be successfully resolved as part of horizontal similarity, but all counterparty names in that shared partition yield a high (e.g., satisfying a defined threshold) Jaro-Winkler similarity score then the entity resolution compute device 120 may use the longest text string (counterparty name) as the resolved entity for all occurrences of that counterparty in that shared partition.

Referring to FIG. 6, as indicated in block 354, the entity resolution compute device 120 may match counterparty names across a shared partition of same email ID (e.g., also a breadcrumb) and/or across a shared partition of same phone number (e.g., also a breadcrumb). In block 356, in the illustrative embodiment, if one of such occurrences was identified to be successfully resolved as part of the horizontal similarity, and all other counterparty names in that shared partition yield a high Jaro-Winkler similarity score, then the entity resolution compute device 120 inherits the resolved identity from that horizontal similarity, for all occurrences of that counterparty in that shared partition. If one of such occurrences was identified to be successfully resolved as part of the vertical similarity determination, and all other counterparty names in that shared partition yield a high Jaro-Winkler similarity score, then the entity resolution compute device 120 may inherit the resolved entity from that vertical similarity, for all occurrences of that counterparty in that shared partition, as indicated in block 358. In the illustrative embodiment, the entity resolution compute device 120 may perform the above operations recursively for other breadcrumbs, as indicated in block 360.

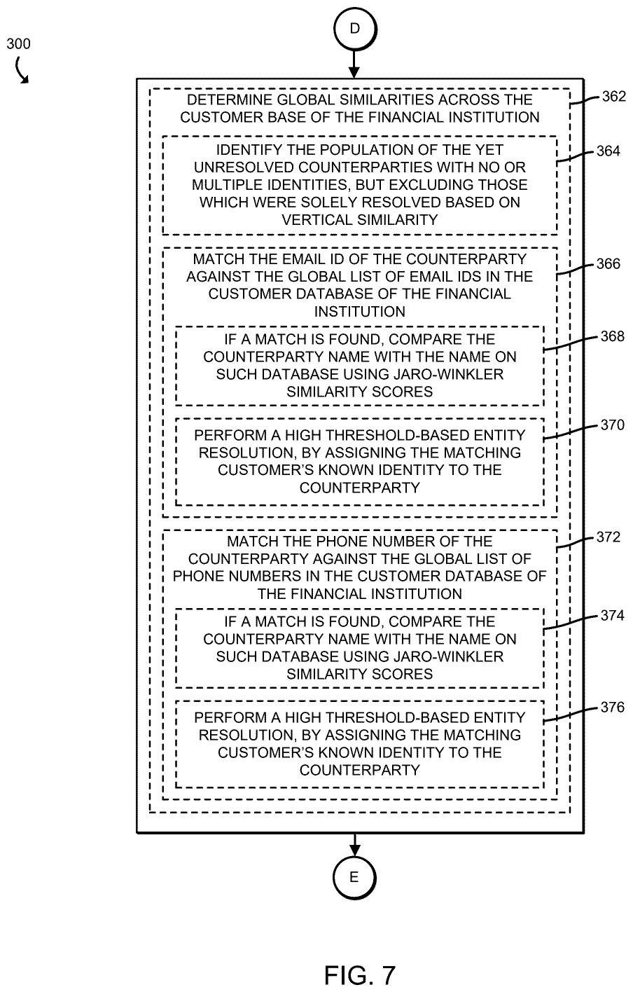

Referring now to FIG. 7, the entity resolution compute device 120 may determine global similarities across the customer base of the financial institution 110, as indicated in block 362. In doing so, and as indicated in block 364, the entity resolution compute device 120 may identity the population of the yet unresolved counterparties with no or multiple identities, but excluding those which were solely resolved based on vertical similarity (e.g., in block 358). That is, if the entity resolution device 120 can find a better match in the customer database based on associated email or phone number, the entity resolution compute device 120 can update the vertical resolution to be even more accurate by associating and giving the identity of a known customer to the counterparty in that partition. In determining global similarities, the entity resolution compute device 120 may match the email ID of the counterparty against the global list of email IDs in the customer database of the financial institution 110. If a match is found, the entity resolution compute device 120 may compare the counterparty name with the name on such database using Jaro-Winkler similarity scores, as indicated in block 368. The entity resolution compute device 120 may perform a high threshold-based entity resolution, by assigning the matching customer's known identity to the counterparty, as indicated in block 370. Additionally or alternatively, the entity resolution compute device 120 may match the phone number of the counterparty against the global list of phone numbers in the customer database of the financial institution 110, as indicated in block 372. As indicated in block 374, if a match is found, the entity resolution compute device 120 may compare the counterparty name with the name on the database using Jaro-Winkler similarity scores. In block 376, the entity resolution compute device 120 may perform a high threshold-based entity resolution, by assigning the matching customer's known identity to the customer.

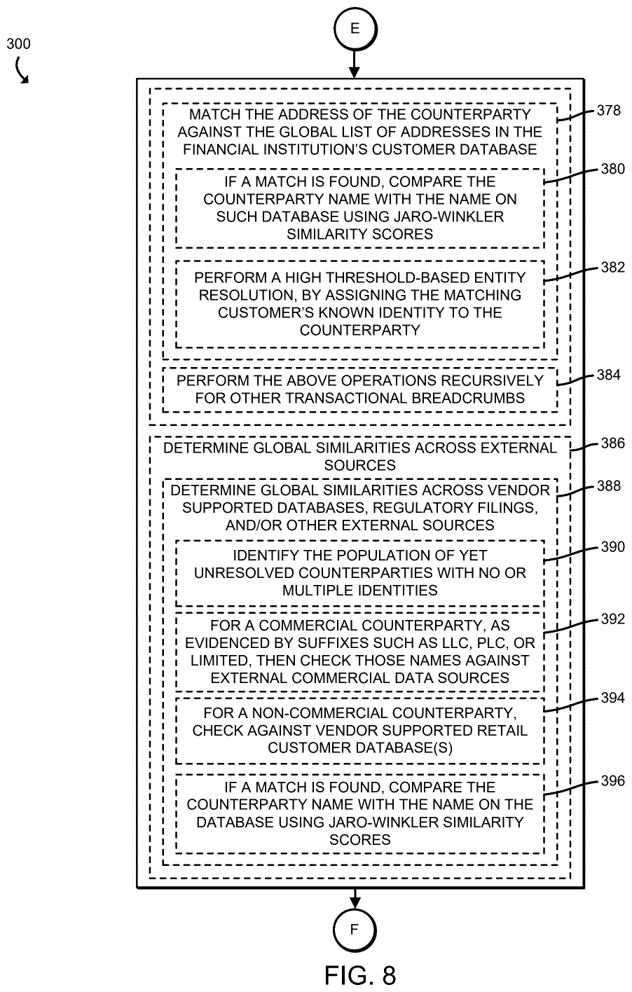

Referring now to FIG. 8, the entity resolution compute device 120 may match the address of the counterparty against the global list of addresses in the customer database of the financial institution 110, as indicated in block 378. In doing so, if a match is found, the entity resolution compute device 120 may compare the counterparty name with the name on the database using Jaro-Winkler similarity scores, as indicated in block 380. Further, and as indicated in block 382, the entity resolution compute device 120 may perform a high threshold-based entity resolution, by assigning the matching customer's known identity to the counterparty. In block 384, the entity resolution compute device 120 may perform the above operations recursively for other transactional breadcrumbs, as indicated in block 384. Further, in block 386, the entity resolution compute device 120 may determine global similarities across external sources. In doing so, and as indicated in block 388, the entity resolution compute device 120 may determine global similarities across vendor supported databases, regulatory filings, and/or other external sources. As indicated in block 390, the entity resolution compute device 120 may identify the population of yet unresolved counterparties with no or multiple identities. For a commercial counterparty, as evidenced by suffixes such as “LLC”, “PLC”, or “LIMITED”, the entity resolution compute device 120, in the illustrative embodiment, checks the name against external commercial data sources, as indicated in block 392. Further, for a non-commercial counterparty, the entity resolution compute device 120 may check against vendor supported retail customer database(s), as indicated in block 394. If a match is found, the entity resolution compute device 120 may compare the counterparty name with the name on the database using Jaro-Winkler similarity scores, as indicated in block 396.

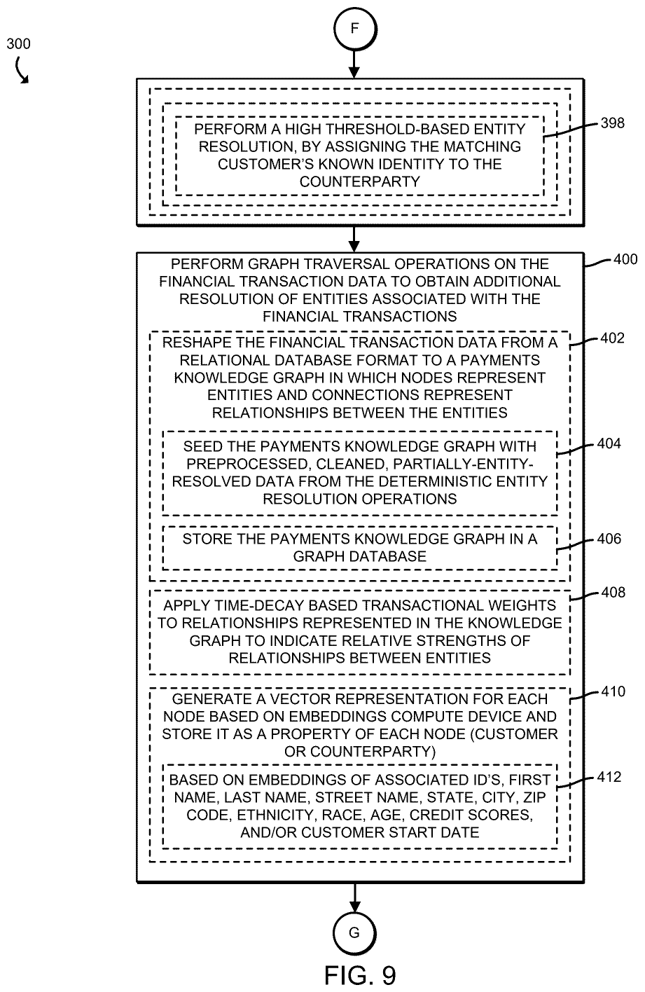

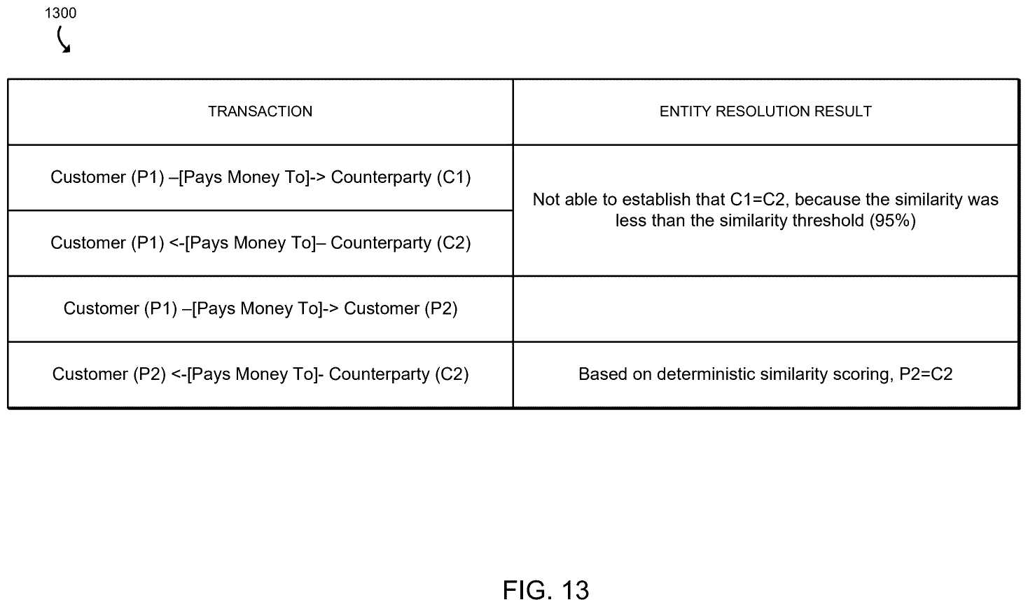

Referring now to FIG. 9, in block 398, the entity resolution compute device 120 may perform a high threshold-based entity resolution, by assigning the matching customer's known identity to the counterparty. Switching to a different mode of entity resolution, the entity resolution compute device 120, in the illustrative embodiment, performs graph traversal operations on the financial transaction data to obtain additional resolution of entities associated with the financial transactions, as indicated in block 400. In doing so, and as indicated in block 402, the entity resolution compute device 120 reshapes the financial transaction data from a relational database format to a payments knowledge graph. In the illustrative embodiment, the entity resolution compute device 120 seeds the payments knowledge graph with preprocessed, cleaned, partially-entity-resolved data from the deterministic entity resolution operations, as indicated in block 404. Further, and as indicated in block 406, the entity resolution compute device 120 stores the payments knowledge graph in a graph database (e.g., the graph database 132). In some embodiments, the graph database is a Neo4j graph database. As indicated in block 408, the entity resolution compute device 120 may apply time-decay based transactional weights to relationships represented in the knowledge graph to indicate the strengths of the relationships. Through these operations, additional information about relationships among the entities may be revealed, as shown in the chart 1300 of FIG. 13. As indicated in block 410, the entity resolution compute device 120 may generate a vector representation for each node and store it as a property of each node (e.g., customer or counterparty). In doing so, and as indicated in block 412, the entity resolution compute device 120 may generate a vector representation and store it as a node property based on based on one or more of associated IDs, first name, last name, street name, city, zip code, ethnicity, race, age, credit scores, and/or customer start date.

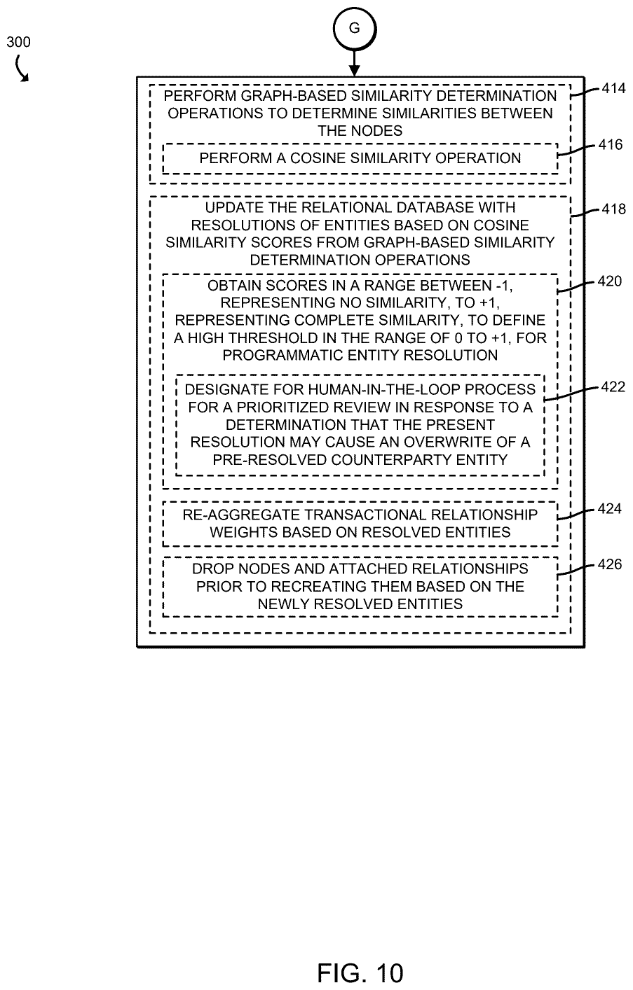

Referring now to FIG. 10, the entity resolution compute device 120, in the illustrative embodiment, also performs graph-based similarity determination operations to determine similarities between the nodes, as indicated in block 414. In doing so, the entity resolution compute device 120 may perform a cosine similarity operation, as indicated in block 416. In a cosine similarity operation, the entity resolution compute device 120 may determine the similarity between two vectors based on the cosine of an angle between the two vectors. The cosine represents whether the vectors are pointing in approximately the same direction, indicating similarity. As indicated in block 418, the entity resolution compute device 120 updates the relational database 130 with resolutions of entities based on similarity scores from the graph-based similarity determination operations. In doing so, the entity resolution compute device 120 may obtain scores in a range between −1, representing no similarity, to +1, representing complete similarity, to define a high threshold in the range of 0 to +1, for programmatic entity resolution, as indicated in block 420. The entity resolution compute device 120 may designate the resolution for a human-in-the-loop process (e.g., for a prioritized review), in response to a determination that the present resolution may cause an overwrite of a pre-resolved counterparty entity, as indicated in block 422. The entity resolution compute device 120, in the illustrative embodiment, re-aggregates transactional relationship weights based on the resolved entities, as indicated in block 424 of FIG. 10. Further, and as indicated in block 426 on FIG. 10, the entity resolution compute device drops nodes and attached relationships prior to recreating them based on the newly resolved entities.

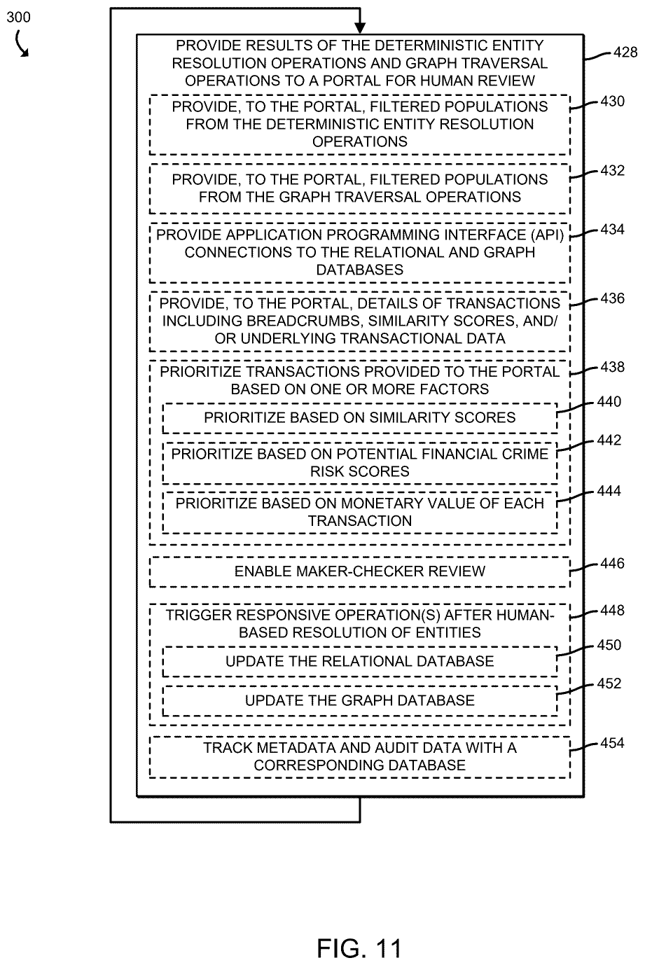

Referring now to FIG. 11, the entity resolution compute device 120, in the illustrative embodiment, provides the results of entity resolution operations (e.g., deterministic and graph traversal operations) to a portal (e.g., a user interface) for human review (e.g., human-in-the-loop entity resolution), as indicated in block 428. In doing so, and as indicated in block 430, the entity resolution compute device 120 provides, to the portal, filtered populations from the deterministic entity resolution operations. Similarly, and as indicated in block 432, the entity resolution compute device 120 provides, to the portal, filtered populations from the graph traversal operations. In the illustrative embodiment, and as indicated in block 434, the entity resolution compute device 120 provides application programming interface (API) connections to the relational database 130 and the graph database 132, thereby enabling the portal to query and receive responsive data from the databases as users (e.g., of the user compute devices 160, 162) review the transactions flagged for human review and related financial transaction data. As indicated in block 436, the entity resolution compute device 120 provides, to the portal, details of the financial transactions. Those details may include breadcrumbs (e.g., the transaction breadcrumb data), similarity scores (e.g., the vertical similarity scores, horizontal similarity scores, and similarity determinations made from the graph traversal operations), and/or the underlying transactional data. The entity resolution compute device 120 may provide other information to the portal as well.

The entity resolution compute device 120 may prioritize financial transactions represented in the data provided to the portal based on one or more factors, as indicated in block 438. For example, and as indicated in block 440, the entity resolution compute device 120 may prioritize the financial transactions based on the similarity scores (e.g., in ascending or descending order). Additionally or alternatively, the entity resolution compute device 120 may prioritize the financial transactions based on potential financial crime scores (e.g., based on one or more rules or models trained to assign a risk of potential financial crime based on properties of a financial transaction or set of financial transactions), as indicated in block 442, and/or based on the monetary value of each transaction, as indicated in block 444. Further, and as indicated in block 446, the entity resolution compute device 120 may also enable maker-checker review, by which an initial reviewer evaluates a set of financial transaction data to reach a conclusion as to the identity of an entity and a secondary reviewer is provided the conclusion and the underlying data, and indicates whether he or she agrees with the conclusion.

The entity resolution compute device 120 may trigger a responsive action after the human-based resolution of one or more entities, as indicated in block 448. In doing so, the entity resolution compute device 120 may update the relational database 130 as indicated in block 450. Additionally or alternatively, the entity resolution compute device 120 may update the graph database, as indicated in block 452. Further, the entity resolution compute device 120 may track metadata and audit data (e.g., indicative of the reasons for which a given entity was determined to have a particular identity) with a corresponding database (e.g., in the data storage 222), as indicated in block 454. The method 300 may repeatedly perform the operations associated with the portal as additional results are received. While the operations of the method 300 are described in a particular sequence, it should be understood that in other embodiments, operations may be performed in a different order and/or in parallel (e.g., obtaining additional financial transaction data while performing deterministic and/or graph traversal based entity resolution operations on an existing set of financial transaction data).

Referring now to FIG. 14, in a diagram 1400 of an embodiment of the system 100 focusing on compute devices of the financial institution 110, an embodiment of the entity resolution compute device 1420 (e.g., similar to the entity resolution compute device 120) is communicatively connected to a financial transactions processing device 1460 (e.g., similar to the financial transaction compute device 140) via an internal network (e.g., LAN, WAN, etc.) 1490. The entity resolution compute device 1420 includes a financial transactions relational database 1430, a customer information relational database 1432, and embeddings compute device 1434, a payments knowledge graph database 1436, a retrieval augmented compute device 1440, a vector search compute device 1442, and a retrieval compute device 1444. The financial transactions processing device 1460 includes payment rails 1470, 1472, 1474 (e.g., compute devices or other processing components configured to process transactions associated with corresponding payment channels).

In the diagram 1400, the flows 2a/3a represent reshaping of relational data as a graph. The flows 2b/3b represent a process to consume certain data points to create embeddings before being loaded in a graph as properties (#4). The user compute device 1450 works with the retrieval augmented compute device 1440 to utilize the vector search compute device 1442 for retrieving knowledge from the payments knowledge graph database 1436 (#5b). Further, the user compute device 1452 works with the retrieval compute device 1444 to utilize the vector search compute device 1442 for retrieving knowledge from the payments knowledge graph database 1436 (#6b). Additionally, the user compute device 1454 works with the retrieval compute device 1444 for directly retrieving knowledge from the payments knowledge graph database 1436 (#7b). Multimodality is thus enabled via a well-orchestrated microservices architecture, to utilize user compute devices in different forms to interact with the payments knowledge graph database 1436 and enrich it with resolved entities via feedback loops (5b, 6b, 7b) that update the payment knowledge graph database 1436. The user compute devices 1452, 1454 can take multiple forms, including a generic user interface (UI) to interact with the payments knowledge graph database 1436 for read-write operations or a human-in-the-loop (HITL) UI to fetch insights from the payments knowledge graph database 1436, the financial transactions relational database 1430, and the customer information relational database 1432 for review and explainable updates to the payments knowledge graph database 1436.

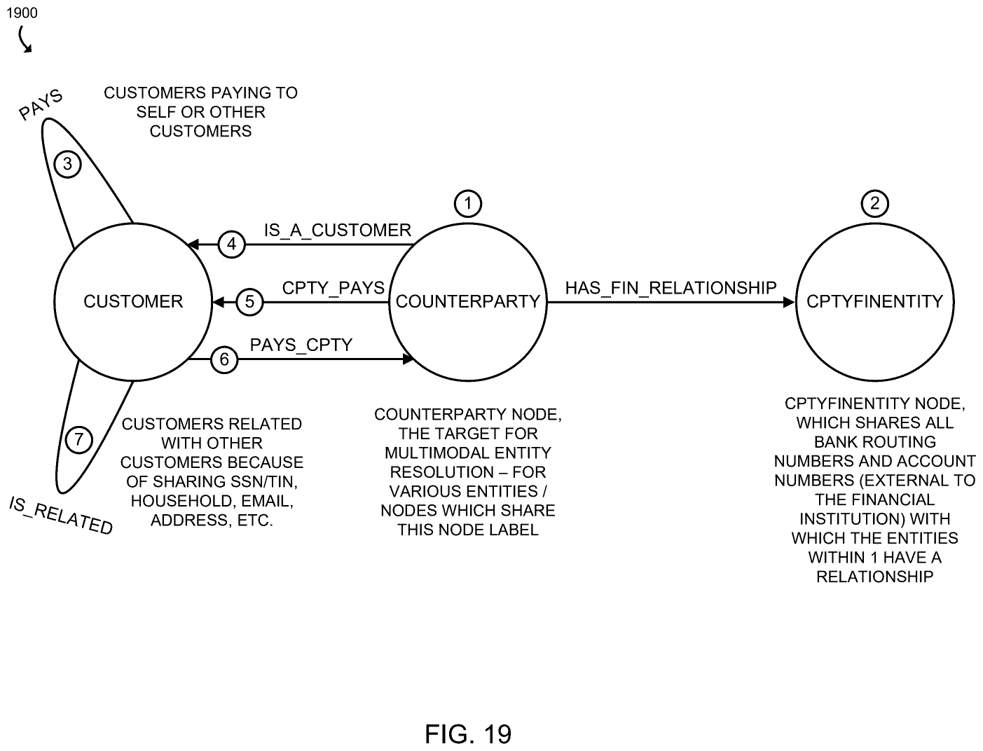

The user compute device 1450 may be embodied as an edge computing device, for real time efficient information retrieval for providing a continuous improvement (CI) feedback loop into the embeddings compute device 1434, which then enriches the payments knowledge graph database 1436 (#5c). The retrieval augmented compute device 1440 includes a pretrained model, enriched with the schema of the payments knowledge graph database 1436 and with API hooks in the query logs of the payments knowledge graph database 1436 (for reinforced learning of successful and efficient queries as they are executed via 5b, 6b, and 7b) to be able to offer an intelligent natural language medium to turn search phrases into cypher queries for information retrieval from the payments knowledge graph database 1436. The core of the entity resolution within the entity resolution compute device 1420 happens as follows: In 2a and 3a, deterministic entity resolution is performed. The operations correspond with FIGS. 4 and 19 and the Jaro-Winkler algorithm referenced above. In 5b and 6b, graph data science algorithms-based entity resolution is performed as users utilize user compute devices 1450 and 1452, to address fraud, money laundering, and product recommendation problems. In 7b, human-in-the-loop augmented entity resolution is performed, which relates to the human-in-the-loop (HITL) UI referenced above. In at least some embodiments, the entity resolution updates to the payments knowledge graph database 1436 have the following components for audits and explainability. One component is programmatic entity resolution based on thresholds-driven supervised machine learning or thresholds-driven unsupervised machine learning. A second component is human review augmented entity resolution, the HITL process, which includes a UI based review and approval process to directly mutate the graph for entity resolution or a human-in-the-loop-learning feedback to the programmatic entity resolution based on thresholds-driven unsupervised machine learning.

The system 100 of FIG. 1 (of which the system 1400 of FIG. 14 may be an embodiment), in the illustrative embodiment, utilizes (e.g., in association with the embeddings compute device 1434 of FIG. 14) embeddings (e.g., numerical representations of objects) in performing entity resolution operations. The knowledge graph may be utilized for financial crime detection, identifying customers with similar spending behaviors, identifying customers with concentration parameters (e.g., risk to flood, supply-chain, etc.), and the like. Such discoveries are made efficient by how the system reshapes and stores relational information as a graph, allowing for faster graph traversal-based retrievals. However, such a system may still require humans to traverse the graph with what they know or how deep they can traverse. These traversals may also be limited by human knowledge of how best to use the graph, while the connected data patterns are constantly shifting. A saved query to traverse the graph may be stuck in an old-behavior detection while a fraudster has moved to exploit another way to defraud. Alternatively, an evolving normalization in usage of robotaxis by the customer base (e.g., as detected through the payments), is an early warning to rethink the auto-loan portfolio in such regions. Additionally or alternatively, the financial institution 110 could curtail exposure to certain markets and/or create new markets or expand elsewhere by linking shifting climate change dynamics. All of the above situations are dependent on new ways of discovering and traversing enterprise knowledge, by embracing constant change. Machine learning and AI is best suited for these situations. However, unlike humans, computerized systems rely on provided information in a machine-understandable way. Embeddings fulfill that role. The outcome of mathematical embeddings is a mathematical vector (e.g., numerical list), which once captured as indexed properties on a graph (e.g., on nodes or relationships) can then be used by the vector search compute device 1442 for faster search and retrieval.

Considering the data footprint of a financial institution such as the financial institution 110, use of different forms of embeddings can be beneficial. Those forms of embeddings may include text embeddings to convert text (e.g., notes attached to a payment, customer feedback, voice to text conversations, etc.) to embeddings. Additionally or alternatively, the embeddings may include temporal embeddings for dates as a unit and/or day, month, year, hour, minute, seconds, etc. Categorical embeddings may represent routing numbers, zip codes, IP addresses, and the like. Spatial embeddings may represent geolocations, distances between geolocations, sea levels, and the like. Numerical embeddings may be utilized to represent normalized and scaled transaction amounts, predetermined transactional weights for the relationships, and the like. Given the potential scale of disparate types of input embeddings, additional operations may be performed before the data is stored in the payments knowledge graph database 1436 to be used by the retrieval compute devices 1440, 1444 via the vector search compute device 1442. Those operations may include feature engineering and extraction of relevant embeddings, normalization across various embeddings to ensure that they all share a consistent scale, integration of the selected embeddings in a unified vector, and/or dimensionality reduction to reduce the number of input features while preserving the most relevant information. The dimensionality reduction may be performed dynamically and the dimensionality reduction method may be selected as a function of the use case. The feature reduction may be selected from a set that includes principal component analysis (PCA), for linear dimensionality reduction, t-distributed stochastic neighbor embedding (t-SNE) for non-linear dimensionality reduction, autoencoders, as part of a neural network architecture for unsupervised learning, and/or others.

Once they are created, the embeddings may be loaded onto the payments knowledge graph database 1436 as a node property or a relationship property, and indexed (e.g., in the graph database 1436) to be efficiently used by the vector search compute device 1442. As part of that process, compute devices of the system 100 may utilize graph algorithms such as cosine similarity or the Euclidean distance between nodes, for identifying node similarities and linking prediction between the node vectors. If there is a strong association established, this would lead to the possibility of those entities being resolved as one. The compute devices may additionally or alternatively utilize graph neural networks (GNN) that can learn from the structural and relationship properties from these embedding vectors, to recommend and deduplicate nodes (entities). These are some of the methods using graph data science algorithms-based entity resolution, referred above.

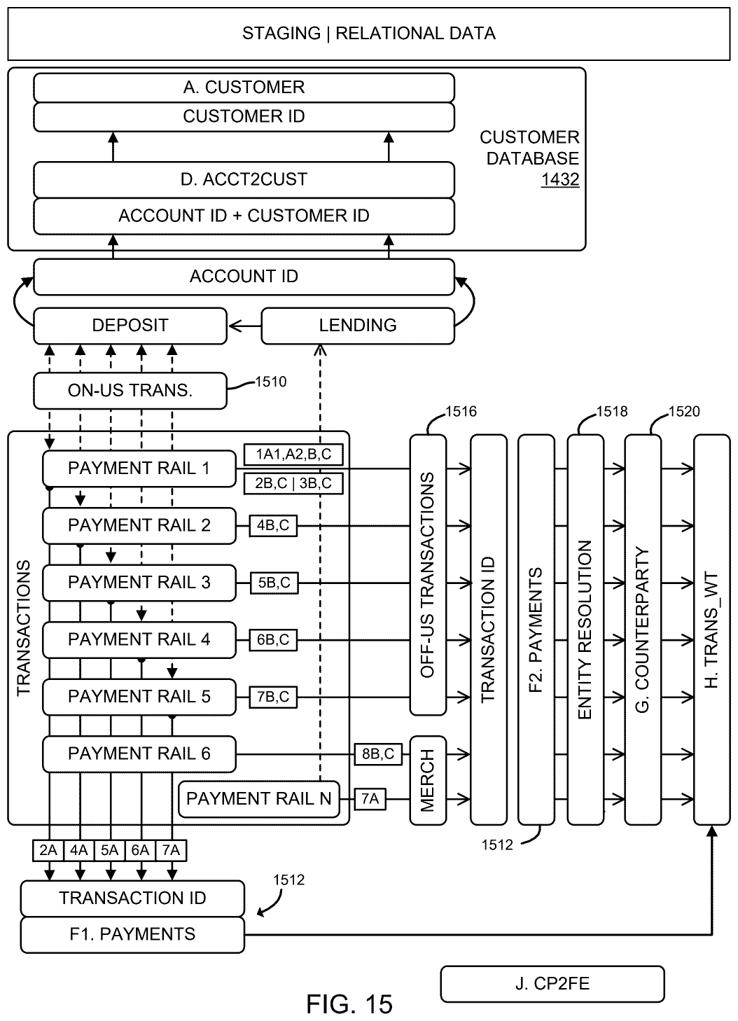

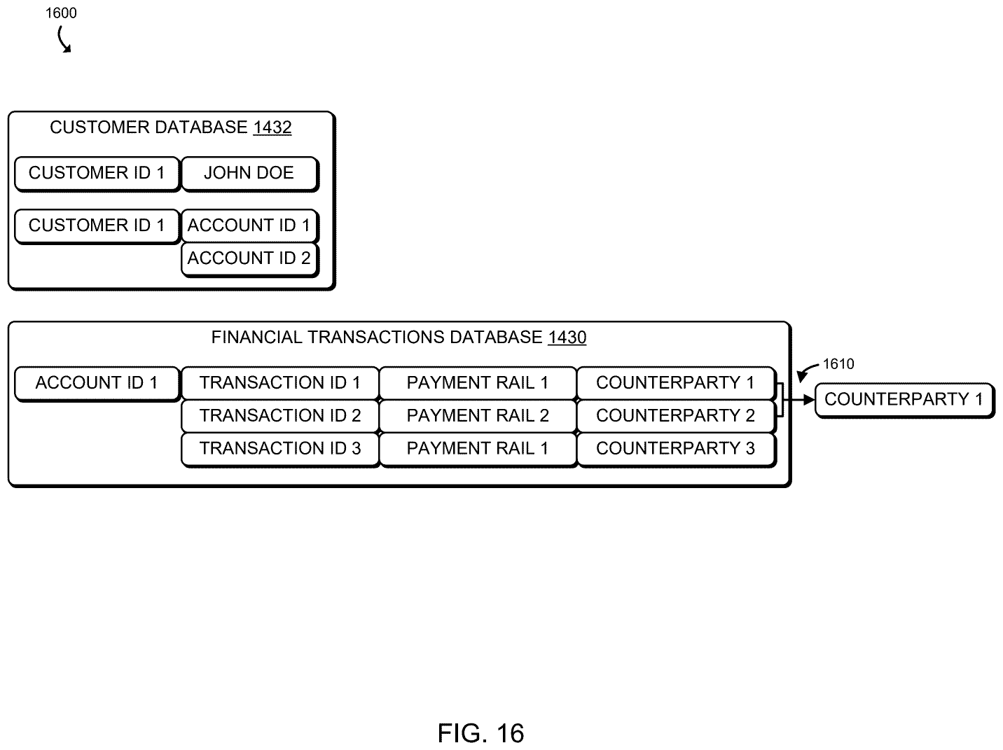

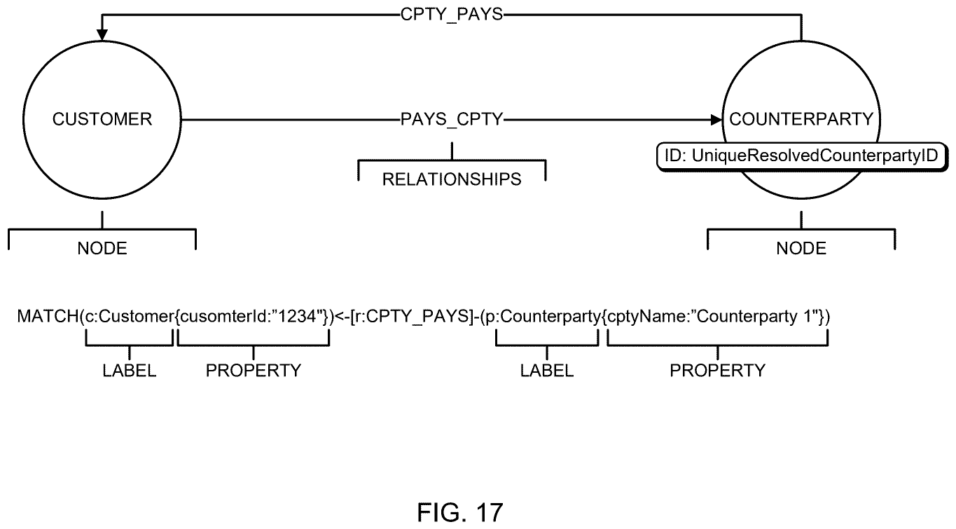

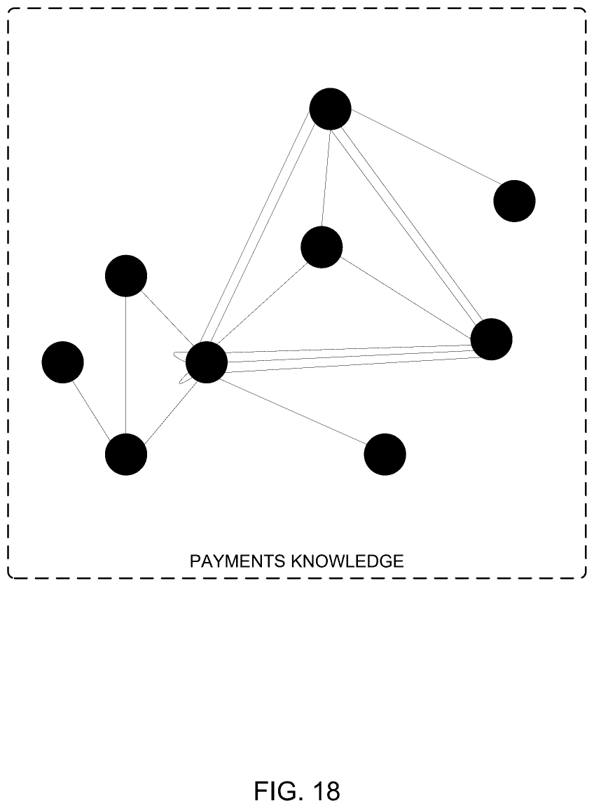

FIG. 15 represents a flow of operations that may be utilized in at least some embodiments to reshape relational data associated with the financial institution 110 to a graph database. Specifically, FIG. 15 represents a staging phase and expands upon the databases 1430, 1432 of FIG. 14. In FIG. 15, element 1510 represents transactions originating and settling within the networks of the financial institution 110. Further, elements 1512 represent the financial transactions database 1430. Element 1516 represents transactions originating and/or settling outside the network of the financial institution 110 with external entities or financial institutions via payment networks such as NACHA (National Automated Clearinghouse Association), Fedwire, Swift, Zelle, and the like. The element 1512 labeled “F1. PAYMENTS” corresponds with element 1510 (e.g., ON-US TRANSACTIONS, where entity resolution is not performed). Further, the element 1512 labeled “F2. PAYMENTS” corresponds with element 1516 (e.g., OFF-US TRANSACTIONS, where entity resolution is performed, because these transactions involve external counterparties). Further, element 1518 represents deterministic entity resolution and HITL augmented resolution (e.g., 2a/3a from FIG. 14). Referring now to FIG. 16, a diagram 1600 represents a result 1610 of performing deterministic entity resolution and HITL augmented entity resolution (e.g., corresponding to operations 2a/3a in FIG. 14) operations. The result 1610 of the operations is that counterparty 1 and counterparty 2 in the financial transactions database 1430 have been deduplicated and resolved as counterparty 1. Element 1518 in FIG. 15 corresponds with the result 1610 in FIG. 16. Further, the element 1520 (G. COUNTERPARTY) in FIG. 15 corresponds with “COUNTERPARTY 1” shown in FIG. 16. That is, FIG. 16 represents an example of how leveraging the databases 1430, 1432 and the operations 2a/3a of FIG. 14 accomplishes deterministic entity resolution and feeds the payments knowledge graph database 1436 of FIG. 14. FIG. 17 illustrates the resolved counterparty (post entity resolution), with a ‘UniqueResolvedCounterpartyID’. The identifier prevents a situation in which there may be ‘n’ unresolved separate nodes, as many relationships, and a noisy graph with limited discernable relationship characteristics. FIG. 17 is indicative of how deterministic entity resolution may actually manifest in the graph. FIG. 18 represents the mapping of the data to a graph database (e.g., the payments knowledge graph database 1436). That is, FIG. 18 represents a high level view of how a payments knowledge graph ontology may be structured in at least some embodiments.

Referring to the diagram 1900 of FIG. 19, based on deterministic high threshold-based entity resolution, the system 100 may perform the following operations. If a counterparty, transacting via #5 or #6 in the diagram 1900, is established as an existing customer, the customer is given an existing customer ID. This is done irrespective of whether the entity has a well-defined ID in the form of a bank routing and account number, a phone number, an email address, or the like. The system may retain those pieces of information, but henceforth, that counterparty is considered as resolved to be known by the identity of the customer. However, if the entity is not directly transacting using #5 or #6, the system may infer, based on other means, that the counterparty is in fact a customer of the financial institution 110. As such, the system may again resolve that counterparty's identity by giving it the identity of the determined customer and establishing (#4) relationship. Example scenarios are provided below in Table 1:

TABLE 1
Suppose Counterparty P1 −[#5 CPTY_PAYS]−> Customer C1
...but we also know that Customer C1 −[#3 PAYS]−> Customer C2
...and Customer C2's name or other transactional breadcrumbs helps us establish that it is same
as Counterparty P1 −> then we give it the identity of Customer C2
Suppose Counterparty P2 <−[#6 PAYS_CPTY]− Customer C1
...but we also know that Customer C1 −[#7 IS_RELATED]−> Customer C2
...and Customer C2's name or other transactional breadcrumbs helps us establish that it is same
as Counterparty P2 −> then we give it the identity of Customer C2

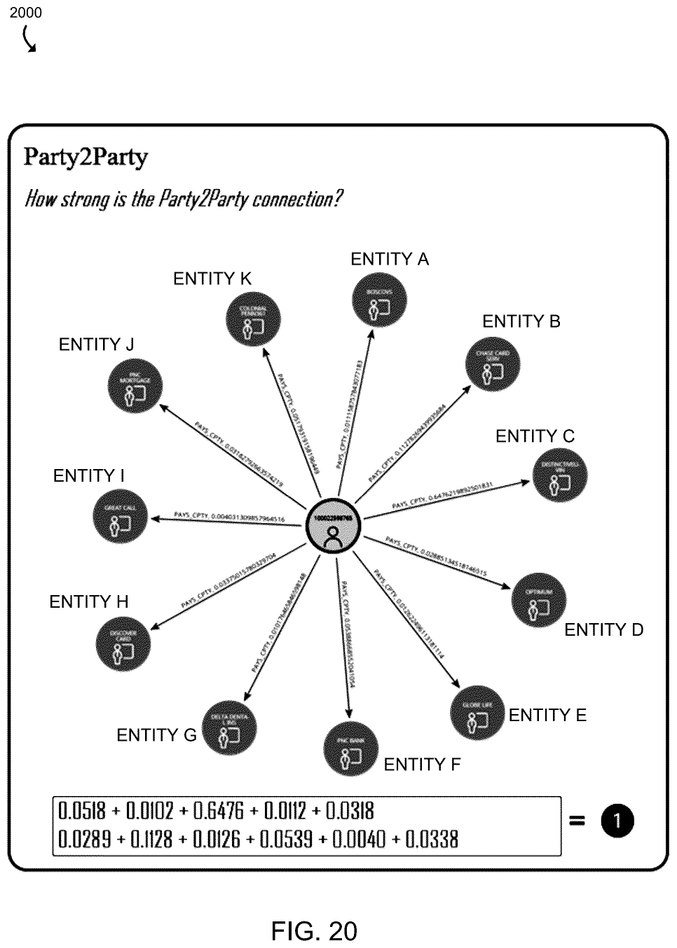

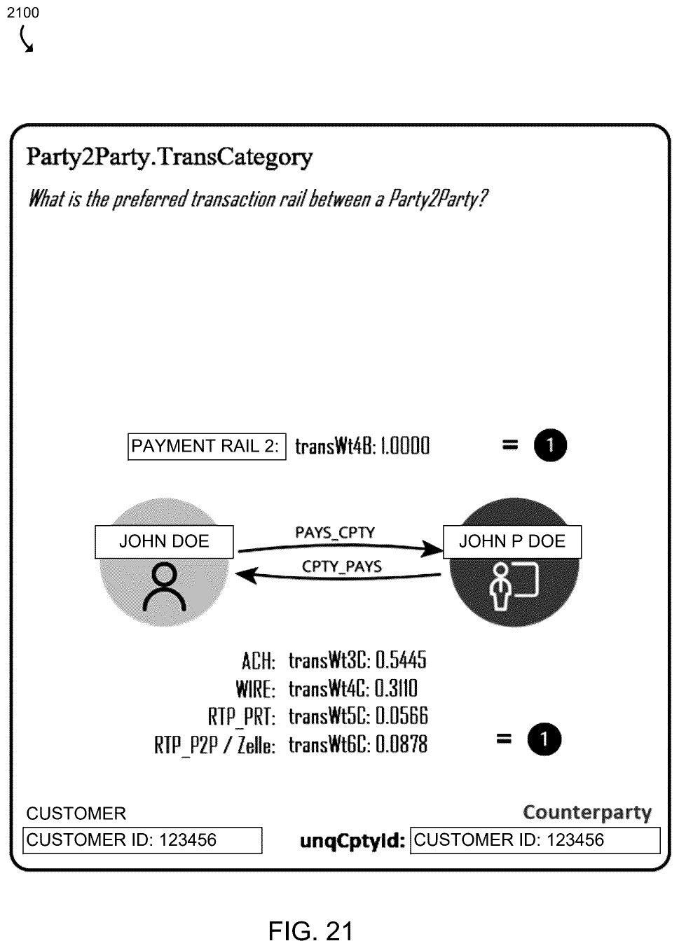

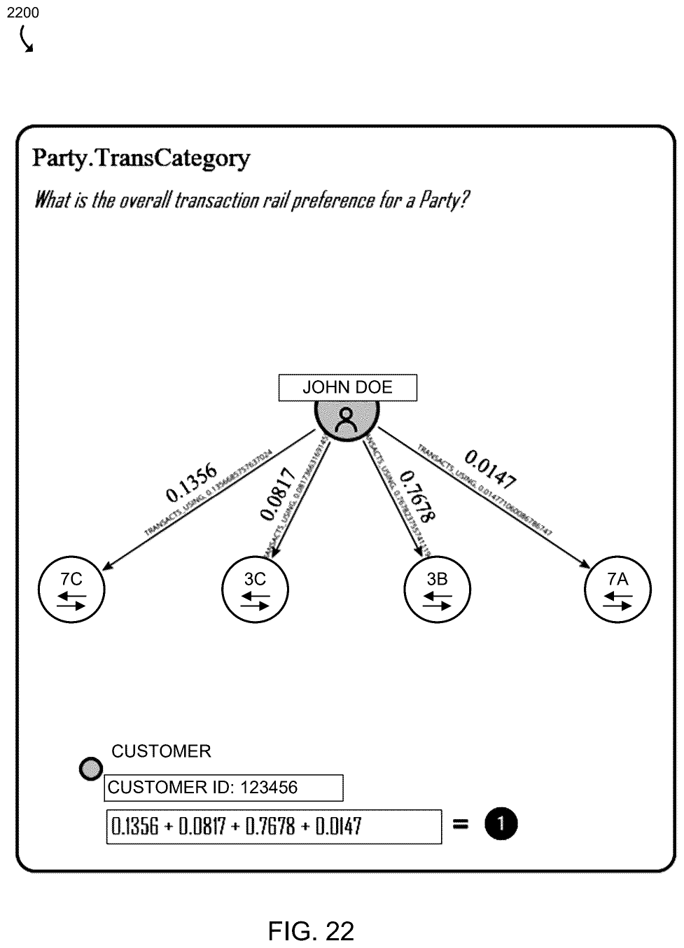

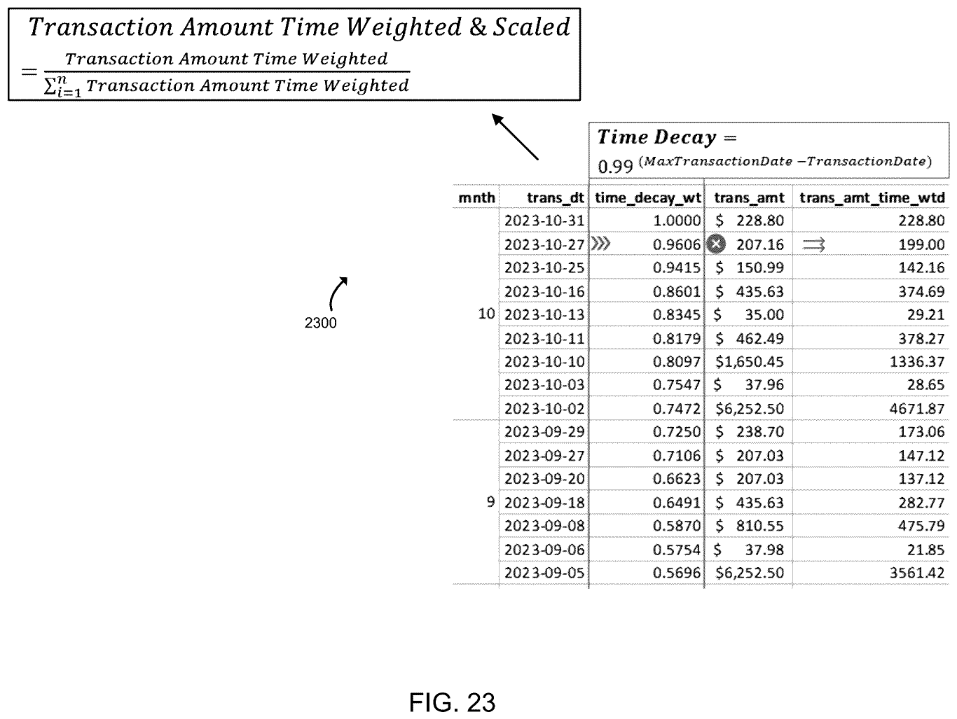

Regarding the financial transactions relational database 1430, an important aspect of the creation of that database is the standardization that is performed to organize the data to support #3, #5, and #6 in the diagram 1900. This is an important data pre-preprocessing and structuring phase that standardizes transactions from various payment rails (e.g., the payment rails 1470, 1472, 1474 of FIG. 14) to help shape and store them in the payments knowledge graph ontology. The diagrams 2000, 2100, 2200, 2300 of FIGS. 20-23 illustrate operations that occur in step 2a represented in the diagram 1400 of FIG. 14 and how those operations are related to bindings, as described above.

While certain illustrative embodiments have been described in detail in the drawings and the foregoing description, such an illustration and description is to be considered as exemplary and not restrictive in character, it being understood that only illustrative embodiments have been shown and described and that all changes and modifications that come within the spirit of the disclosure are desired to be protected. There exist a plurality of advantages of the present disclosure arising from the various features of the apparatus, systems, and methods described herein. It will be noted that alternative embodiments of the apparatus, systems, and methods of the present disclosure may not include all of the features described, yet still benefit from at least some of the advantages of such features. Those of ordinary skill in the art may readily devise their own implementations of the apparatus, systems, and methods that incorporate one or more of the features of the present disclosure.

### EXAMPLES

Illustrative examples of the technologies disclosed herein are provided below. An embodiment of the technologies may include any one or more, and any combination of, the examples described below.
Example 1 includes a compute device comprising circuitry configured to obtain financial transaction data indicative of financial transactions associated with a financial institution; perform one or more deterministic operations on the obtained financial transaction data in a relational database format to resolve identities of entities associated with the financial transactions; and perform one or more graph traversal operations on the financial transaction data to resolve additional identities of the entities associated with the financial transactions.
Example 2 includes the subject matter of Example 1, and wherein the circuitry is further configured to provide results of the deterministic entity resolution operations and the graph traversal operations to a portal for human review.
Example 3 includes the subject matter of any of Examples 1 and 2, and wherein to obtain financial transaction data comprises to obtain financial transaction data indicative of at least one of a transfer of money from a customer of the financial institution to another customer of the financial institution, a transfer of money from a customer of the financial institution to a party that is not a customer of the financial institution, a transfer of money from a party that is not a customer of the financial institution to a customer of the financial institution, a transfer of money from the financial institution to a customer of the financial institution, a transfer of money from the financial institution to a party that is not a customer of the financial institution, a transfer of money from a customer of the financial institution to the financial institution, or a transfer of money from a party that is not a customer of the financial institution to the financial institution.
Example 4 includes the subject matter of any of Examples 1-3, and wherein to perform one or more deterministic operations comprises to identify counterparties to be analyzed.
Example 5 includes the subject matter of any of Examples 1-4, and wherein to perform one or more deterministic operations comprises to identify breadcrumbs from transactions for resolving counterparty identities.
Example 6 includes the subject matter of any of Examples 1-5, and wherein to perform one or more deterministic operations comprises to define horizontal and vertical deterministic entity resolution rules specific to a set of payment rail models.
Example 7 includes the subject matter of any of Examples 1-6, and wherein to perform one or more deterministic operations comprises to perform data cleaning operations.
Example 8 includes the subject matter of any of Examples 1-7, and wherein to perform data cleaning operations comprises to convert letters to uppercase.
Example 9 includes the subject matter of any of Examples 1-8, and wherein to perform data cleaning operations comprises to convert acronyms, abbreviations, and truncated terms to legible text.
Example 10 includes the subject matter of any of Examples 1-9, and wherein to convert acronyms, abbreviations, and truncated terms to legible text comprises to convert acronyms, abbreviations, and truncated terms to legible text with a pre-trained language model.
Example 11 includes the subject matter of any of Examples 1-10, and wherein to perform one or more deterministic operations comprises to execute rules and programmatically resolve entities bounded by predefined explainable thresholds.
Example 12 includes the subject matter of any of Examples 1-11, and wherein to perform one or more deterministic operations comprises to determine horizontal similarities.
Example 13 includes the subject matter of any of Examples 1-12, and wherein to determine horizontal similarities comprises to match names of a customer and a counterparty on a transaction record based on a Jaro-Winkler algorithm to generate a similarity score; match phone, email address, zip code, IP address of the counterparty associated with a payment rail transaction record, with corresponding parameters of the customer to generate a binary classifier; and perform a high threshold-based entity resolution by assigning a known identity of the customer to the counterparty.
Example 14 includes the subject matter of any of Examples 1-13, and wherein to perform one or more deterministic operations comprises to determine vertical similarities.
Example 15 includes the subject matter of any of Examples 1-14, and wherein to determine vertical similarities comprises to identify a population of yet unresolved counterparties with no or multiple identities.
Example 16 includes the subject matter of any of Examples 1-15, and wherein to determine vertical similarities further comprises to match counterparty names across a shared partition of same routing and account numbers, same email identifier, same phone number, or one or more other breadcrumbs.
Example 17 includes the subject matter of any of Examples 1-16, and wherein to match counterparty names across a shared partition of same routing and account numbers comprises to inherit a resolved entity from a horizontal similarity for occurrences of the counterparty in the shared partition if the occurrence was identified to be successfully resolved as part of horizontal similarity and other counterparty names in the shared partition yield a high Jaro-Winkler similarity score.
Example 18 includes the subject matter of any of Examples 1-17, and wherein to match counterparty names across a shared partition of same email identifier comprises to inherit a resolved entity from a horizontal similarity for occurrences of the counterparty in the shared partition if the occurrence was identified to be successfully resolved as part of a horizontal similarity and other counterparty names in the shared partition yield a high Jaro-Winkler similarity score.
Example 19 includes the subject matter of any of Examples 1-18, and wherein to match counterparty names across a shared partition of same phone number comprises to inherit a resolved entity from a horizontal similarity for occurrences of the counterparty in the shared partition if the occurrence was identified to be successfully resolved as part of a horizontal similarity determination and other counterparty names in the shared partition yield a high Jaro-Winkler similarity score.
Example 20 includes the subject matter of any of Examples 1-19, and wherein to perform one or more deterministic operations comprises to determine global similarities across a customer base of the financial institution.
Example 21 includes the subject matter of any of Examples 1-20, and wherein the circuitry is further configured to determine global similarities across external sources.
Example 22 includes the subject matter of any of Examples 1-21, and wherein to perform one or more graph traversal operations comprises to reshape the financial transaction data from the relational database format to a payments knowledge graph in which nodes represent entities and connections between the nodes represent relationships between the entities.
Example 23 includes the subject matter of any of Examples 1-22, and wherein the circuitry is further configured to seed the payments knowledge graph with data produced from the one or more deterministic operations performed on the financial transaction data.
Example 24 includes the subject matter of any of Examples 1-23, and wherein the circuitry is further configured to apply time-decay based weights to relationships represented in the payments knowledge graph to indicate relative strengths of the relationships.
Example 25 includes the subject matter of any of Examples 1-24, and wherein the circuitry is further configured to generate a vector representation for each node and store the vector representation as a property of the corresponding node.
Example 26 includes the subject matter of any of Examples 1-25, and wherein the circuitry is further configured to generate a vector representation based on an identifiers, first name, last name, street name, state, city, zip code, ethnicity, race, age, credit score, or customer start date.
Example 27 includes the subject matter of any of Examples 1-26, and wherein the circuitry is further configured to perform one or more graph-based similarity determination operations to determine similarities between the nodes.
Example 28 includes the subject matter of any of Examples 1-27, and wherein to perform one or more graph-based similarity determination operations comprises to perform a cosine similarity operation.
Example 29 includes the subject matter of any of Examples 1-28, and wherein the circuitry is further configured to update the relational database with resolutions of entities based on at least one similarity score produced from the one or more graph-based similarity determination operations.
Example 30 includes the subject matter of any of Examples 1-29, and wherein the circuitry is further configured to re-aggregate transaction relationship weights based on resolved entities; and drop nodes and attached relationships from the payments knowledge graph prior to recreating one or more nodes and relationships based on the resolved entities.
Example 31 includes the subject matter of any of Examples 1-30, and wherein the circuitry is further configured to provide results of the deterministic entity resolution operations and graph traversal operations to a portal for human review, including providing, to the portal, filtered populations from the deterministic entity resolution operations, providing, to the portal, filtered populations from the graph traversal operations, providing application programming interface connections to the relational database and a graph database that stores a payments knowledge graph based on the financial transaction data, and providing, to the portal, details of the financial transactions, including breadcrumb data, similarity scores, and underlying transactional data.
Example 32 includes the subject matter of any of Examples 1-31, and wherein the circuitry is further configured to prioritize the financial transactions provided to the portal based on at least one of similarity scores, potential financial crime risk scores, or monetary values of the financial transactions.
Example 33 includes the subject matter of any of Examples 1-32, and wherein the circuitry is further configured to enable maker-checker review in the portal.
Example 34 includes the subject matter of any of Examples 1-33, and wherein the circuitry is further configured to trigger a responsive action after a human-based resolution of one or more of the entities in the portal, wherein the responsive action includes updating at least one of the relational database or the graph database.
Example 35 includes the subject matter of any of Examples 1-34, and wherein the circuitry is further configured to track metadata and audit data with a corresponding database.
Example 36 includes a method comprising obtaining, by a compute device, financial transaction data indicative of financial transactions associated with a financial institution; performing, by the compute device, one or more deterministic operations on the obtained financial transaction data in a relational database format to resolve identities of entities associated with the financial transactions; and performing, by the compute device, one or more graph traversal operations on the financial transaction data to resolve additional identities of the entities associated with the financial transactions.
Example 37 includes the subject matter of Example 36, and further including providing, by the compute device, results of the deterministic entity resolution operations and the graph traversal operations to a portal for human review.
Example 38 includes the subject matter of any of Examples 36 and 37, and wherein obtaining financial transaction data comprises obtaining financial transaction data indicative of at least one of a transfer of money from a customer of the financial institution to another customer of the financial institution, a transfer of money from a customer of the financial institution to a party that is not a customer of the financial institution, a transfer of money from a party that is not a customer of the financial institution to a customer of the financial institution, a transfer of money from the financial institution to a customer of the financial institution, a transfer of money from the financial institution to a party that is not a customer of the financial institution, a transfer of money from a customer of the financial institution to the financial institution, or a transfer of money from a party that is not a customer of the financial institution to the financial institution.
Example 39 includes the subject matter of any of Examples 36-38, and wherein performing one or more deterministic operations comprises identifying counterparties to be analyzed.
Example 40 includes the subject matter of any of Examples 36-39, and wherein performing one or more deterministic operations comprises identifying breadcrumbs from transactions for resolving counterparty identities.
Example 41 includes the subject matter of any of Examples 36-40, and wherein performing one or more deterministic operations comprises defining horizontal and vertical deterministic entity resolution rules specific to a set of payment rail models.
Example 42 includes the subject matter of any of Examples 36-41, and wherein performing one or more deterministic operations comprises performing data cleaning operations.
Example 43 includes the subject matter of any of Examples 36-42, and wherein performing data cleaning operations comprises converting letters to uppercase.
Example 44 includes the subject matter of any of Examples 36-43, and wherein performing data cleaning operations comprises converting acronyms, abbreviations, and truncated terms to legible text.
Example 45 includes the subject matter of any of Examples 36-44, and wherein converting acronyms, abbreviations, and truncated terms to legible text comprises converting acronyms, abbreviations, and truncated terms to legible text with a pre-trained language model.
Example 46 includes the subject matter of any of Examples 36-45, and wherein performing one or more deterministic operations comprises executing rules and programmatically resolve entities bounded by predefined explainable thresholds.
Example 47 includes the subject matter of any of Examples 36-46, and wherein performing one or more deterministic operations comprises determining horizontal similarities.
Example 48 includes the subject matter of any of Examples 36-47, and wherein determining horizontal similarities comprises matching names of a customer and a counterparty on a transaction record based on a Jaro-Winkler algorithm to generate a similarity score; matching phone, email address, zip code, IP address of the counterparty associated with a payment rail transaction record, with corresponding parameters of the customer to generate a binary classifier; and performing a high threshold-based entity resolution by assigning a known identity of the customer to the counterparty.
Example 49 includes the subject matter of any of Examples 36-48, and wherein performing one or more deterministic operations comprises determining vertical similarities.
Example 50 includes the subject matter of any of Examples 36-49, and wherein determining vertical similarities comprises identifying a population of yet unresolved counterparties with no or multiple identities.
Example 51 includes the subject matter of any of Examples 36-50, and wherein determining vertical similarities further comprises matching counterparty names across a shared partition of same routing and account numbers, same email identifier, same phone number, or one or more other breadcrumbs.
Example 52 includes the subject matter of any of Examples 36-51, and wherein matching counterparty names across a shared partition of same routing and account numbers comprises inheriting a resolved entity from a horizontal similarity for occurrences of the counterparty in the shared partition if the occurrence was identified to be successfully resolved as part of horizontal similarity and other counterparty names in the shared partition yield a high Jaro-Winkler similarity score.
Example 53 includes the subject matter of any of Examples 36-52, and wherein matching counterparty names across a shared partition of same email identifier comprises inheriting a resolved entity from a horizontal similarity for occurrences of the counterparty in the shared partition if the occurrence was identified to be successfully resolved as part of a horizontal similarity determination and other counterparty names in the shared partition yield a high Jaro-Winkler similarity score.
Example 54 includes the subject matter of any of Examples 36-53, and wherein matching counterparty names across a shared partition of same phone number comprises inheriting a resolved entity from a horizontal similarity for occurrences of the counterparty in the shared partition if the occurrence was identified to be successfully resolved as part of a horizontal similarity determination and other counterparty names in the shared partition yield a high Jaro-Winkler similarity score.
Example 55 includes the subject matter of any of Examples 36-54, and wherein performing one or more deterministic operations comprises determining global similarities across a customer base of the financial institution.
Example 56 includes the subject matter of any of Examples 36-55, and further including determining, by the compute device, global similarities across external sources.
Example 57 includes the subject matter of any of Examples 36-56, and wherein performing one or more graph traversal operations comprises reshaping the financial transaction data from the relational database format to a payments knowledge graph in which nodes represent entities and connections between the nodes represent relationships between the entities.
Example 58 includes the subject matter of any of Examples 36-57, and further including seeding, by the compute device, the payments knowledge graph with data produced from the one or more deterministic operations performed on the financial transaction data.
Example 59 includes the subject matter of any of Examples 36-58, and further including applying, by the compute device, time-based weights to relationships represented in the payments knowledge graph to indicate strengths of the relationships.
Example 60 includes the subject matter of any of Examples 36-59, and further including generating, by the compute device, a vector representation for each node and storing the vector representation as a property of the corresponding node.
Example 61 includes the subject matter of any of Examples 36-60, and further including generating, by the compute device, a vector representation based on an identifiers, first name, last name, street name, state, city, zip code, ethnicity, race, age, credit score, or customer start date.
Example 62 includes the subject matter of any of Examples 36-61, and further including performing, by the compute device, one or more graph-based similarity determination operations to determine similarities between the nodes.
Example 63 includes the subject matter of any of Examples 36-62, and wherein performing one or more graph-based similarity determination operations comprises performing a cosine similarity operation.
Example 64 includes the subject matter of any of Examples 36-63, and further including updating, by the compute device, the relational database with resolutions of entities based on at least one similarity score produced from the one or more graph-based similarity determination operations.
Example 65 includes the subject matter of any of Examples 36-64, and further including re-aggregating, by the compute device, transaction relationship weights based on resolved entities; and dropping, by the compute device, nodes and attached relationships from the payments knowledge graph prior to recreating one or more nodes and relationships based on the resolved entities.
Example 66 includes the subject matter of any of Examples 36-65, and further including providing, by the compute device, results of the deterministic entity resolution operations and graph traversal operations to a portal for human review, including providing, to the portal, filtered populations from the deterministic entity resolution operations, providing, to the portal, filtered populations from the graph traversal operations, providing application programming interface connections to the relational database and a graph database that stores a payments knowledge graph based on the financial transaction data, and providing, to the portal, details of the financial transactions, including breadcrumb data, similarity scores, and underlying transactional data.
Example 67 includes the subject matter of any of Examples 36-66, and further including prioritizing, by the compute device, the financial transactions provided to the portal based on at least one of similarity scores, potential financial crime risk scores, or monetary values of the financial transactions.
Example 68 includes the subject matter of any of Examples 36-67, and further including enabling, by the compute device, maker-checker review in the portal.
Example 69 includes the subject matter of any of Examples 36-68, and further including triggering, by the compute device, a responsive action after a human-based resolution of one or more of the entities in the portal, wherein the responsive action includes updating at least one of the relational database or the graph database.
Example 70 includes the subject matter of any of Examples 36-69, and further including tracking, by the compute device, metadata and audit data with a corresponding database.
Example 71 includes one or more machine-readable storage media comprising a plurality of instructions stored thereon that, in response to being executed, cause a compute device to obtain financial transaction data indicative of financial transactions associated with a financial institution; perform one or more deterministic operations on the obtained financial transaction data in a relational database format to resolve identities of entities associated with the financial transactions; and perform one or more graph traversal operations on the financial transaction data to resolve additional identities of the entities associated with the financial transactions.
Example 72 includes the subject matter of Example 71, and wherein the instructions further cause the compute device to provide results of the deterministic entity resolution operations and the graph traversal operations to a portal for human review.
Example 73 includes the subject matter of any of Examples 71 and 72, and wherein to obtain financial transaction data comprises to obtain financial transaction data indicative of at least one of a transfer of money from a customer of the financial institution to another customer of the financial institution, a transfer of money from a customer of the financial institution to a party that is not a customer of the financial institution, a transfer of money from a party that is not a customer of the financial institution to a customer of the financial institution, a transfer of money from the financial institution to a customer of the financial institution, a transfer of money from the financial institution to a party that is not a customer of the financial institution, a transfer of money from a customer of the financial institution to the financial institution, or a transfer of money from a party that is not a customer of the financial institution to the financial institution.
Example 74 includes the subject matter of any of Examples 71-73, and wherein to perform one or more deterministic operations comprises to identify counterparties to be analyzed.
Example 75 includes the subject matter of any of Examples 71-74, and wherein to perform one or more deterministic operations comprises to identify breadcrumbs from transactions for resolving counterparty identities.
Example 76 includes the subject matter of any of Examples 71-75, and wherein to perform one or more deterministic operations comprises to define horizontal and vertical deterministic entity resolution rules specific to a set of payment rail models.
Example 77 includes the subject matter of any of Examples 71-76, and wherein to perform one or more deterministic operations comprises to perform data cleaning operations.
Example 78 includes the subject matter of any of Examples 71-77, and wherein to perform data cleaning operations comprises to convert letters to uppercase.
Example 79 includes the subject matter of any of Examples 71-78, and wherein to perform data cleaning operations comprises to convert acronyms, abbreviations, and truncated terms to legible text.
Example 80 includes the subject matter of any of Examples 71-79, and wherein to convert acronyms, abbreviations, and truncated terms to legible text comprises to convert acronyms, abbreviations, and truncated terms to legible text with a pre-trained language model.
Example 81 includes the subject matter of any of Examples 71-80, and wherein to perform one or more deterministic operations comprises to execute rules and programmatically resolve entities bounded by predefined explainable thresholds.
Example 82 includes the subject matter of any of Examples 71-81, and wherein to perform one or more deterministic operations comprises to determine horizontal similarities.
Example 83 includes the subject matter of any of Examples 71-82, and wherein to determine horizontal similarities comprises to match names of a customer and a counterparty on a transaction record based on a Jaro-Winkler algorithm to generate a similarity score; match phone, email address, zip code, IP address of the counterparty associated with a payment rail transaction record, with corresponding parameters of the customer to generate a binary classifier; and perform a high threshold-based entity resolution by assigning a known identity of the customer to the counterparty.
Example 84 includes the subject matter of any of Examples 71-83, and wherein to perform one or more deterministic operations comprises to determine vertical similarities.
Example 85 includes the subject matter of any of Examples 71-84, and wherein to determine vertical similarities comprises to identify a population of yet unresolved counterparties with no or multiple identities.
Example 86 includes the subject matter of any of Examples 71-85, and wherein to determine vertical similarities further comprises to match counterparty names across a shared partition of same routing and account numbers, same email identifier, same phone number, or one or more other breadcrumbs.
Example 87 includes the subject matter of any of Examples 71-86, and wherein to match counterparty names across a shared partition of same routing and account numbers comprises to inherit a resolved entity from a horizontal similarity for occurrences of the counterparty in the shared partition if the occurrence was identified to be successfully resolved as part of horizontal similarity and other counterparty names in the shared partition yield a high Jaro-Winkler similarity score.
Example 88 includes the subject matter of any of Examples 71-87, and wherein to match counterparty names across a shared partition of same email identifier comprises to inherit a resolved entity from a horizontal similarity for occurrences of the counterparty in the shared partition if the occurrence was identified to be successfully resolved as part of a horizontal similarity determination and other counterparty names in the shared partition yield a high Jaro-Winkler similarity score.
Example 89 includes the subject matter of any of Examples 71-88, and wherein to match counterparty names across a shared partition of same phone number comprises to inherit a resolved entity from a horizontal similarity for occurrences of the counterparty in the shared partition if the occurrence was identified to be successfully resolved as part of a horizontal similarity determination and other counterparty names in the shared partition yield a high Jaro-Winkler similarity score.
Example 90 includes the subject matter of any of Examples 71-89, and wherein to perform one or more deterministic operations comprises to determine global similarities across a customer base of the financial institution.
Example 91 includes the subject matter of any of Examples 71-90, and wherein the instructions further cause the compute device to determine global similarities across external sources.
Example 92 includes the subject matter of any of Examples 71-91, and wherein to perform one or more graph traversal operations comprises to reshape the financial transaction data from the relational database format to a payments knowledge graph in which nodes represent entities and connections between the nodes represent relationships between the entities.
Example 93 includes the subject matter of any of Examples 71-92, and wherein the instructions further cause the compute device to seed the payments knowledge graph with data produced from the one or more deterministic operations performed on the financial transaction data.
Example 94 includes the subject matter of any of Examples 71-93, and wherein the instructions further cause the compute device to apply time-based weights to relationships represented in the payments knowledge graph to indicate strengths of the relationships.
Example 95 includes the subject matter of any of Examples 71-94, and wherein the instructions further cause the compute device to generate a vector representation for each node and store the vector representation as a property of the corresponding node.
Example 96 includes the subject matter of any of Examples 71-95, and wherein the instructions further cause the compute device to generate a vector representation based on an identifiers, first name, last name, street name, state, city, zip code, ethnicity, race, age, credit score, or customer start date.
Example 97 includes the subject matter of any of Examples 71-96, and wherein the instructions further cause the compute device to perform one or more graph-based similarity determination operations to determine similarities between the nodes.
Example 98 includes the subject matter of any of Examples 71-97, and wherein to perform one or more graph-based similarity determination operations comprises to perform a cosine similarity operation.
Example 99 includes the subject matter of any of Examples 71-98, and wherein the instructions further cause the compute device to update the relational database with resolutions of entities based on at least one similarity score produced from the one or more graph-based similarity determination operations.
Example 100 includes the subject matter of any of Examples 71-99, and wherein the instructions further cause the compute device to re-aggregate transaction relationship weights based on resolved entities; and drop nodes and attached relationships from the payments knowledge graph prior to recreating one or more nodes and relationships based on the resolved entities.
Example 101 includes the subject matter of any of Examples 71-100, and wherein the instructions further cause the compute device to provide results of the deterministic entity resolution operations and graph traversal operations to a portal for human review, including providing, to the portal, filtered populations from the deterministic entity resolution operations, providing, to the portal, filtered populations from the graph traversal operations, providing application programming interface connections to the relational database and a graph database that stores a payments knowledge graph based on the financial transaction data, and providing, to the portal, details of the financial transactions, including breadcrumb data, similarity scores, and underlying transactional data.
Example 102 includes the subject matter of any of Examples 71-101, and wherein the instructions further cause the compute device to prioritize the financial transactions provided to the portal based on at least one of similarity scores, potential financial crime risk scores, or monetary values of the financial transactions.
Example 103 includes the subject matter of any of Examples 71-102, and wherein the instructions further cause the compute device to enable maker-checker review in the portal.
Example 104 includes the subject matter of any of Examples 71-103, and wherein the instructions further cause the compute device to trigger a responsive action after a human-based resolution of one or more of the entities in the portal, wherein the responsive action includes updating at least one of the relational database or the graph database.
Example 105 includes the subject matter of any of Examples 71-104, and wherein the instructions further cause the compute device to track metadata and audit data with a corresponding database.

1. A compute device comprising:
circuitry configured to:
obtain financial transaction data indicative of financial transactions associated with a financial institution;
perform one or more deterministic operations on the obtained financial transaction data in a relational database format to resolve identities of entities associated with the financial transactions; and
perform one or more graph traversal operations on the financial transaction data to resolve additional identities of the entities associated with the financial transactions.

2. The compute device of claim 1, wherein the circuitry is further configured to provide results of the deterministic entity resolution operations and the graph traversal operations to a portal for human review.

3. The compute device of claim 1, wherein to perform one or more deterministic operations comprises: (i) to identify counterparties to be analyzed; (ii) to identify breadcrumbs from transactions for resolving counterparty identities; (iii) to define horizontal and vertical deterministic entity resolution rules specific to a set of payment rail models; and/or (iv) to perform data cleaning operations.

4. The compute device of claim 3, wherein to perform data cleaning operations comprises: (i) to convert letters to uppercase; and/or (ii) to perform data cleaning operations comprises to convert acronyms, abbreviations, and truncated terms to legible text with a pre-trained language model.

5. The compute device of claim 1, wherein to perform one or more deterministic operations comprises to execute rules and programmatically resolve entities bounded by predefined explainable thresholds.

6. The compute device of claim 1, wherein to perform one or more deterministic operations comprises to determine horizontal similarities by: matching names of a customer and a counterparty on a transaction record based on a Jaro-Winkler algorithm to generate a similarity score; matching phone, email address, zip code, IP address of the counterparty associated with a payment rail transaction record, with corresponding parameters of the customer to generate a binary classifier; and performing a high threshold-based entity resolution by assigning a known identity of the customer to the counterparty.

7. The compute device of claim 1, wherein to perform one or more deterministic operations comprises to determine vertical similarities by identifying a population of yet unresolved counterparties with no or multiple identities that matches counterparty names across a shared partition of same routing and account numbers, same email identifier, same phone number, or one or more other breadcrumbs.

8. The compute device of claim 7, wherein to match counterparty names across a shared partition of same routing and account numbers comprises to inherit a resolved entity from a horizontal similarity for occurrences of the counterparty in the shared partition if the occurrence was identified to be successfully resolved as part of horizontal similarity and other counterparty names in the shared partition yield a high Jaro-Winkler similarity score.

9. The compute device of claim 8, wherein to match counterparty names across a shared partition of same email identifier comprises to inherit a resolved entity from a horizontal similarity for occurrences of the counterparty in the shared partition if the occurrence was identified to be successfully resolved as part of a horizontal similarity and other counterparty names in the shared partition yield a high Jaro-Winkler similarity score.

10. The compute device of claim 1, wherein to perform one or more graph traversal operations comprises to reshape the financial transaction data from the relational database format to a payments knowledge graph in which nodes represent entities and connections between the nodes represent relationships between the entities, and wherein the circuitry is further to seed the payments knowledge graph with data produced from the one or more deterministic operations performed on the financial transaction data.

11. The compute device of claim 10, wherein the circuitry is further configured to apply time-decay based weights to relationships represented in the payments knowledge graph to indicate relative strengths of the relationships.

12. The compute device of claim 10, wherein the circuitry is further configured to generate a vector representation for each node and store the vector representation as a property of the corresponding node.

13. The compute device of claim 1, wherein the circuitry is further configured to perform one or more graph-based similarity determination operations to determine similarities between the nodes and update the relational database with resolutions of entities based on at least one similarity score produced from the one or more graph-based similarity determination operations, re-aggregate transaction relationship weights based on resolved entities; and drop nodes and attached relationships from the payments knowledge graph prior to recreating one or more nodes and relationships based on the resolved entities.

14. The compute device of claim 1, wherein the circuitry is further configured to provide results of the deterministic entity resolution operations and graph traversal operations to a portal for human review, including providing, to the portal, filtered populations from the deterministic entity resolution operations, providing, to the portal, filtered populations from the graph traversal operations, providing application programming interface connections to the relational database and a graph database that stores a payments knowledge graph based on the financial transaction data, and providing, to the portal, details of the financial transactions, including breadcrumb data, similarity scores, and underlying transactional data.

15. The compute device of claim 14, wherein the circuitry is further configured to prioritize the financial transactions provided to the portal based on at least one of similarity scores, potential financial crime risk scores, or monetary values of the financial transactions.

16. The compute device of claim 15, wherein the circuitry is further configured to enable maker-checker review in the portal and trigger a responsive action after a human-based resolution of one or more of the entities in the portal, wherein the responsive action includes updating at least one of the relational database or the graph database.

17. A method comprising:
obtaining, by a compute device, financial transaction data indicative of financial transactions associated with a financial institution;
performing, by the compute device, one or more deterministic operations on the obtained financial transaction data in a relational database format to resolve identities of entities associated with the financial transactions; and
performing, by the compute device, one or more graph traversal operations on the financial transaction data to resolve additional identities of the entities associated with the financial transactions.

18. The method of claim 17, further comprising providing, by the compute device, results of the deterministic entity resolution operations and the graph traversal operations to a portal for human review.

19. The method of claim 17, wherein performing, by the compute device, one or more deterministic operations comprising: (i) to identify counterparties to be analyzed; (ii) to identify breadcrumbs from transactions for resolving counterparty identities; (iii) to define horizontal and vertical deterministic entity resolution rules specific to a set of payment rail models; and/or (iv) to perform data cleaning operations.

20. The method of claim 19, wherein performing data cleaning operations comprises: (i) to convert letters to uppercase; and/or (ii) to perform data cleaning operations comprises to convert acronyms, abbreviations, and truncated terms to legible text with a pre-trained language model.

21. The method of claim 17, wherein performing one or more deterministic operations comprises to execute rules and programmatically resolve entities bounded by predefined explainable thresholds.

22. The method of claim 17, wherein performing one or more deterministic operations comprises to determine horizontal similarities by: matching names of a customer and a counterparty on a transaction record based on a Jaro-Winkler algorithm to generate a similarity score; matching phone, email address, zip code, IP address of the counterparty associated with a payment rail transaction record, with corresponding parameters of the customer to generate a binary classifier; and performing a high threshold-based entity resolution by assigning a known identity of the customer to the counterparty.

23. The method of claim 17, wherein performing one or more deterministic operations comprises to determine vertical similarities by identifying a population of yet unresolved counterparties with no or multiple identities that matches counterparty names across a shared partition of same routing and account numbers, same email identifier, same phone number, or one or more other breadcrumbs.

24. The method of claim 23, wherein matching counterparty names across a shared partition of same routing and account numbers comprises to inherit a resolved entity from a horizontal similarity for occurrences of the counterparty in the shared partition if the occurrence was identified to be successfully resolved as part of horizontal similarity and other counterparty names in the shared partition yield a high Jaro-Winkler similarity score.

25. The method of claim 24, wherein matching counterparty names across a shared partition of same email identifier comprises to inheriting a resolved entity from a horizontal similarity for occurrences of the counterparty in the shared partition if the occurrence was identified to be successfully resolved as part of a horizontal similarity and other counterparty names in the shared partition yield a high Jaro-Winkler similarity score.
